(19) United States
(12) Patent Application Publication
(10) Pub. No.: US 2017/0013323 A1
(43) Pub. Date: Jan. 12, 2017

(54) SYSTEM AND METHOD FOR AUTOMATED MEDIA CONTENT PRODUCTION AND DISTRIBUTION

(71) Applicant: VIA PRODUCTIONS, LLC, Memphis, TN (US)

(72) Inventor: Matthew Whitney, Germantown, TN (US)

(21) Appl. No.: 15/187,743

(22) Filed: Jun. 20, 2016

Related U.S. Application Data
(60) Provisional application No. 62/182,276, filed on Jun. 19, 2015.

(51) Int. Cl. H04N 21/81; H04L 29/06; G06Q 30/06; H04N 21/472; H04N 21/45; G06Q 30/02; H04N 21/2343; H04N 21/2668

(52) U.S. Cl. CPC H04N 21/812; H04N 21/234336; H04L 65/4076; H04N 21/2668; H04N 21/472; H04N 21/4532; G06Q 30/0261; G06Q 30/0255; G06Q 30/0633; G06Q 30/0269; G06Q 30/0273; G06Q 30/0276

(57) ABSTRACT

An automated system and method for media content post-production, including customer order-based customization, customer approval, transcoding and distribution of the media content to broadcasting sites that disseminate audio, audiovisual or print media.

### CROSS-REFERENCE TO RELATED APPLICATIONS

This application claims priority to co-pending U.S. Patent Provisional Application Ser. No. 62/182,276 filed Jun. 19, 2015, which is herein incorporated by reference in its entirety.

### BACKGROUND OF THE INVENTION

The present invention pertains generally to the field of audio-visual media content production, including post-production customization and processing and distribution to media broadcasting stations. More particularly, the present invention provides an automated system and method for media content post-production, including customer order-based customization, customer approval, transcoding and distribution of the media content to broadcasting sites that disseminate audio, audiovisual or print media.

Heretofore, media production and distribution have existed in separate and distinct workflow channels. As an example, advertising production has lacked the ability to be both scalable and customizable, and allow for distribution of “advertising spots.” The term “advertising spot” is a term wisely used and understood in the broadcast advertising industry to mean an advertising commercial of defined length that is aired on broadcast media, including television, radio, web streaming, or the like.

Broadcast advertising, or commercials, are primary revenue generators for commercial television, radio, websites and other streaming media. Advertisers pay a broadcasting station to broadcast a spot based on multiple considerations, including spot length, the time the spot goes out, which channel it is on, and most importantly, which show is airing at the time the spot is to be aired. Spots can vary in length, some being just 5-10 seconds, others going as long as a whole commercial break. Most spots are either 30 or 60 seconds on television, and 15, 30 or 60 seconds on radio, webcasts or other streaming media.

A spot airing in the commercial break of a prime time show will be very expensive, whereas spots that air on lesser watched channels after 12:00 A.M. will be much more affordable, with the price of $5 per 1000 viewers being typical. While the cost per viewer may decrease after 12:00 A.M. fewer viewers will see the ad. For a massive audience, a National Football League Super Bowl spot is the way to go, but the cost of just 30 seconds is going to run around $1-$2 million!

Broadcast media time at broadcasting stations is conventionally purchased by an advertising agency or a media buying agency whose job it is to negotiate the best rates and times for the advertising spots or commercials.

Prior to being aired, the advertising spot must, of course, be produced. Different production modalities are necessitated by the type of broadcasting medium the advertising spot is intended to air on. Audiovisual advertising spots for broadcast on television, webcasts, cable, or other streaming media, will require both video and audio production. Audio advertising spots, such as radio, streaming audio or the like will require only audio production. Similarly, if the broadcast medium requires high definition (“HD”) video and/or audio, or other sound engineering, that will be part of the production workflow as well.

When producing an advertisement for broadcast media, it is critical to understand both the format and the medium to ensure that the advertising spot is effectively reaching a desired target audience.

Radio Advertising: Radio advertising spots are typically purchased with numerous air times in mind. Spots during the top and bottom of the hour are typically more expensive than spots played at the 15-minute marks. Advertisers can select how many times they want their spots to be heard through the course of a day as well as on which shows. Some programs can charge more for an ad spot, depending on their listenership as well as the time of day the show airs. Prime drive time hours between 5 p.m. and 7 p.m. are the most expensive, while late-night ad spots are generally cheapest.

Television Advertising: Television ad spots are very similar in structure to radio advertising. They run at specified times during specified programs. Prime time advertising is 6 p.m. to 10 p.m. and these spots can be very expensive. Ads purchased to run during sporting events are the most expensive, while ads purchased to run during late-night television are typically more affordable. Television ad spots are also more expensive to produce than radio spots and require more design time.

Online Streaming Advertising: There are ad spots in new media as well. Online video sharing sites such as YouTube offer the ability to purchase ad spots within the videos on its sites. These ad spots typically run before a video loads, which the viewer cannot skip or must view for a predetermined period of time. Compared to television advertising spots, they are much more reasonably priced, though one must still spend money to produce the advertising spot.

Local Cable Advertising: Local cable advertising is a popular option among smaller companies that cannot afford national advertising costs. These advertising spots are just like the ones that would run on satellite or network television, but can only be seen in a specific local area served by the local cable provider. This type of advertising spot is ideal for a company marketing to its local area and can be a very effective means to reach out to the community. Prices are generally much lower than national advertising spots and production quality and levels do not need to be as great as that for national advertising spots.

Production of a commercial advertising spot has many associated costs, including production costs, talent costs, copying (known in the industry as “dubs”), and post-production costs for editing or redoing sections of the production.

Production costs may be reduced where pre-produced advertising spots exist. Oftentimes, franchise operators will have access to pre-produced (“canned”) commercials through their franchisor's advertising support system. A canned commercial will typically have an 8-10 second blank space at the end for “tagging” the franchisee's local address and contact information. In this way, the franchisees have access to a professionally produced commercial with limited customization and the franchisors have control over the nature, quality and consistency of the advertising.

Similarly, co-operative advertising (“co-op advertising”) is often used in retail sales where the manufacturers, wholesalers or distributors have professionally pre-produced commercials that have to be used as is or have limited ability for customization by the retailer.

It will be understood by those skilled in art that the media content production, post-production, media buying and distribution for broadcast as currently implemented requires an advertising purchaser to work with disparate service providers, i.e., production facilities, media buying agents, post-production facilities and broadcasting stations in order to launch a desired ad spot. This results in both time and cost inefficiencies for many advertisers on limited advertising budgets and limits the flexibility of customizing the advertising message delivered.

### SUMMARY OF THE INVENTION

It is, therefore, an objective of the present invention to provide a system and method including a single online resource for an advertising spot purchaser to order an advertising spot from a plurality of advertising spot templates, customize the advertising spot template to create a customized advertising spot for the purchaser, manage the workflow of the customized advertising spot, and manage the digital delivery and distribution of the advertising spot to purchaser-designated broadcast media.

It is a further objective of the present invention to provide a system and method that incorporates a media inventory resource that functions as a media consolidator to enable a media purchaser using the system and method to purchase media directly from a broadcasting source, such as a television station, a network, radio stations, internet streaming services, or the like. The media inventory resource obtains media inventory data from a plurality of broadcasting sources and during an advertising ordering process of the system and method, the purchaser is presented with a plurality of options including, without limitation, type of broadcasting medium, local, regional or national broadcast scope, duration of the advertising medium, cost, and broadcast time slot availability, based upon the obtained media inventory data. Once the purchaser selects the options for selecting the media time slots, the system and method automatically updates the purchasers cart and, upon completion of a checkout routine, executes a commercial payment transaction.

It is a further objective of the present invention to provide a system and method that incorporates a media targeting resource that processes data pertaining to consumer behavior in response to advertising, and generates a recommended media buy to the advertising purchaser in the inventive system and method based upon purchaser-specified options, including, without limitation, its target audience, flight dates (the air dates for the advertisement), and preferred media channels for the advertisement. Once the purchaser designates the purchaser-specified options and a resulting recommendation, the system and method automatically updates the purchasers cart and, upon completion of a checkout routine, executes a commercial payment transaction.

### BRIEF DESCRIPTION OF THE DRAWINGS

In the accompanying figures, like elements are identified by like reference numerals among the several preferred embodiments of the present invention.

FIG. 1 is a flow chart illustrating the inventive system for automated media content production, distribution and delivery.

FIG. 2 is a flow chart illustrating the inventive method for automated media content production, distribution and delivery.

FIG. 3 is a flow chart illustrating a sub-system and method for media inventory and media targeting useful with the inventive system and method for automated media content production, distribution and delivery.

FIG. 4 is a screen capture of a login screen of the inventive system.

FIG. 5 is a screen capture of a user registration screen of the inventive system.

FIG. 6 is a screen capture of an end-user license agreement acknowledgment screen of the inventive system.

FIG. 7 is a screen capture of a broadcast medium selection screen of the system of the present invention.

FIG. 8 is a screen capture of a media content selection screen of the system of the present invention.

FIG. 9 is a screen capture of an alternative embodiment of a media content selection screen of the system of the present invention.

FIG. 10 is a screen capture of a first customization screen for selected media content in accordance with the present invention.

FIG. 11 is a screen capture of the first customization screen for the selected media content with a first customization option selected in accordance with the present invention.

FIG. 12 is a screen capture of the first customization screen for the selected media content with a second customization option selected in accordance with the present invention.

FIG. 13 is a screen capture of the first customization screen for the selected media content with a third customization option selected in accordance with the present invention.

FIG. 14 is a screen capture of the first customization screen for the selected media content with a fourth customization option selected in accordance with the present invention.

FIG. 15 is a screen capture of the first customization screen for the selected media content with a fifth customization option selected in accordance with the present invention.

FIG. 16 is a screen capture of the first customization screen for the selected media content with a sixth customization option selected in accordance with the present invention.

FIG. 17 is a screen capture of the first customization screen for the selected media content with a seventh customization option selected in accordance with the present invention.

FIG. 18 is a screen capture of the first customization screen for the selected media content with first traffic option selected in accordance with the present invention.

FIG. 19 is a screen capture of the first customization screen for the selected media content with a second traffic option selected in accordance with the present invention.

FIG. 20 is a screen capture of the first customization screen for the selected media content with a first broadcast station option selected in accordance with the present invention.

FIG. 21 is a screen capture of a broadcast station management screen for active ordered media content in accordance with the present invention.

FIG. 21A is a screen capture of an embodiment of a broadcast station management screen and broadcast station groupings in accordance with the present invention.

FIG. 22 is a screen capture of a shopping cart screen for the selected media as customized by a user in accordance with the present invention.

FIG. 23 is a screen capture of a checkout screen for ordering the selected media as customized by a user in accordance with the present invention.

FIG. 24 is a screen capture of a payment processing screen for ordering the selected media as customized by a user in accordance with the present invention.

FIG. 25 is a screen capture of an order confirmation screen for the ordered selected media as customized by a user in accordance with the present invention.

FIG. 26 is a screen capture of an active order screen for user management of active orders of media content for customization, distribution and delivery to broadcast stations in accordance with the present invention.

FIG. 27 is a screen capture of an active order selected from the active order screen of FIG. 26 illustrating active order user options in accordance with the present invention.

FIG. 27A is a screen capture of an order details screen selected from the active order screen of FIG. 26 illustrating active order details in accordance with the present invention.

FIG. 27B is a screen capture of a traffic screen selected from the active order screen of FIG. 26 illustrating active order traffic information in accordance with the present invention.

FIG. 27C is a screen capture of a market screen selected from the active order screen of FIG. 26 illustrating active order market information in accordance with the present invention.

FIG. 27D is a screen capture of a client screen selected from the active order screen of FIG. 26 illustrating user or client information in accordance with the present invention.

FIG. 28 is a flow chart depicting the method of the present invention from the user login/registration screens to the broadcast medium selection in accordance with the present invention.

FIG. 29 is a flow chart depicting the method of the present invention where a user has selected television as the broadcast medium for the customization, distribution and delivery ordering in accordance with the present invention.

FIG. 30 is a flow chart depicting the method of the present invention where a user has selected satellite as the broadcast medium for the customization, distribution and delivery ordering in accordance with the present invention.

FIG. 31 is a flow chart depicting the method of the present invention where a user has selected internet or streaming media as the broadcast medium for the customization, distribution and delivery ordering in accordance with the present invention.

FIG. 32 is a flow chart depicting the method of the present invention where a user has selected radio as the broadcast medium for the customization, distribution and delivery ordering in accordance with the present invention.

FIG. 33 is a flow chart depicting the method for shopping cart checkout of an order for the media content in accordance with present invention.

FIG. 34 is a flow chart depicting the method of active order management in accordance with the present invention.

### DETAILED DESCRIPTION OF THE PREFERRED EMBODIMENTS

The system and method of the present invention is illustrated with reference to the accompanying Figures, in which reference numerals identify system elements and/or method steps.

As used herein the following terms have the following meanings:

“Advertising spot” is a term widely used and understood in the broadcast advertising industry to mean an advertising commercial of defined length that is aired on broadcast media, including television, radio, web streaming, over the internet, or the like.

“Ad-ID” is the advertising industry standard unique identifier for all commercial assets. The use of Ad-ID helps direct correct assets be delivered to the correct broadcast medium, and ultimately, to the end consumer by providing a central, secure, Web-based source for stakeholders throughout the marketing communications landscape. Ad-ID codes are 12 digits in length, four alpha and eight alphanumeric characters. The first four alpha characters are company identification prefixes. Ad-ID codes are computer generated through a secure, Web-accessible database, located at www.ad-id.org.

“CODEC” is a concatenated term for “coder-decoder” and is used to describe the functioning of a CODEC. Most audio and video file formats use some sort of compression to reduce their file size. CODECs are used to compress these audio and video files when saving the files and then decompressing or decoding the coded files during file playback. Streaming media is also compressed and decompressed during broadcast of live audio or video over the Internet.

“Computer(s)” is intended to include servers, including file servers, webservers, database servers and the like, desktops, laptops, tablets, smartphones, mobile devices or other similar types of devices, including any input devices, display devices or devices that communicate wired or wirelessly therewith.

“Flight” or “Flighting” is a term in the advertising industry that is used to mean a timing pattern in which commercials are scheduled to run during intervals separated by periods in which no advertising messages appear for the advertised item or service. A period of time during which the messages are appearing is a flight.

“Rotation” when used in connection with an ad spot or media content is used to mean the scheduling of advertising in the same program or time period on different days each week (horizontal rotation) or throughout a particular day (vertical rotation) in order to increase advertising exposure to different audiences.

“Transcoding” is the direct analog-to-analog or digital-to-digital conversion of one encoding to another, such as video data files, e.g., Pal, SECAM, NTSC, FLV, MP4, MPEG, etc., audio files, e.g., MP3, WAV, or character encoding, e.g., UTF-8, ISO/IEC 8859. Transcoding effectively translates video, audio or audio video files from one format to a suitable format for playback on different devices.

“Watch Folder” is a file directory that is periodically polled for new content.

The system of the present invention may operate on one or more servers at a single site or on more than one server in a distributed environment. In the case of a single server, the system may be run on an online website, such as WORDPRESS, an open source website creation tool written in PHP. PHP is a server-side scripting language that is especially well-suited to web development and is also useful as a general-purpose programming language. Alternatively, the system may be run on another PHP programming framework or PHP compatible programming framework. It is expressly contemplated that other programming frameworks and system architectures, as currently exist or as may hereinafter be developed, may be employed to allow for the operation and functioning of the method of the present invention.

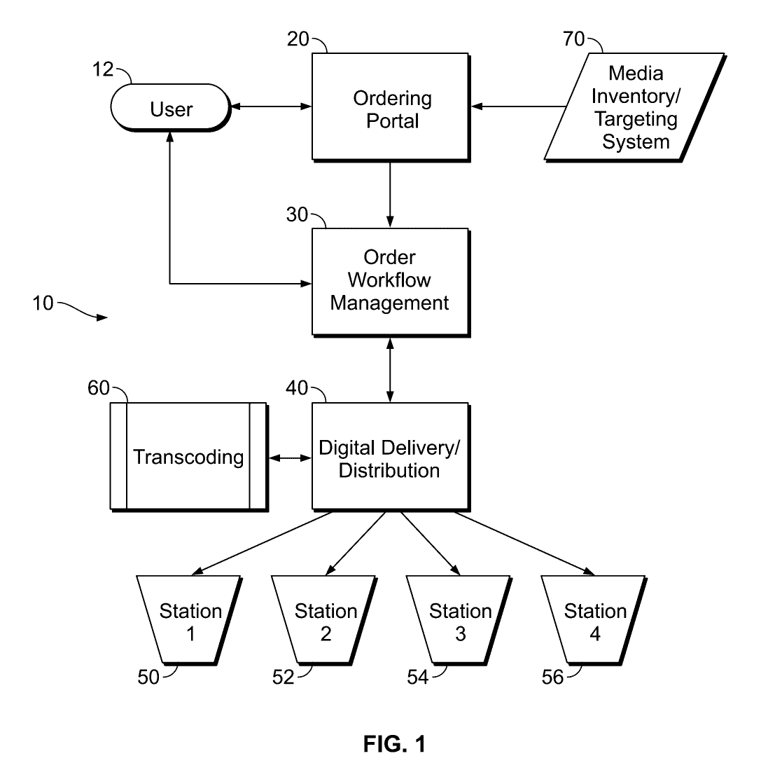

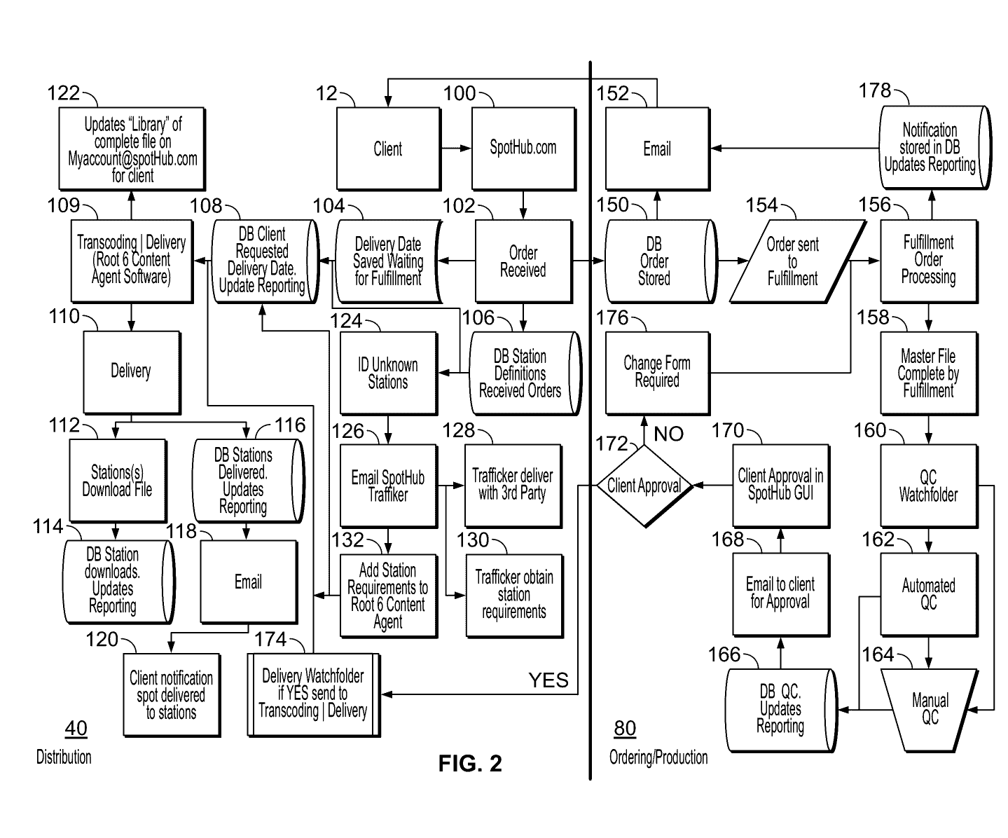

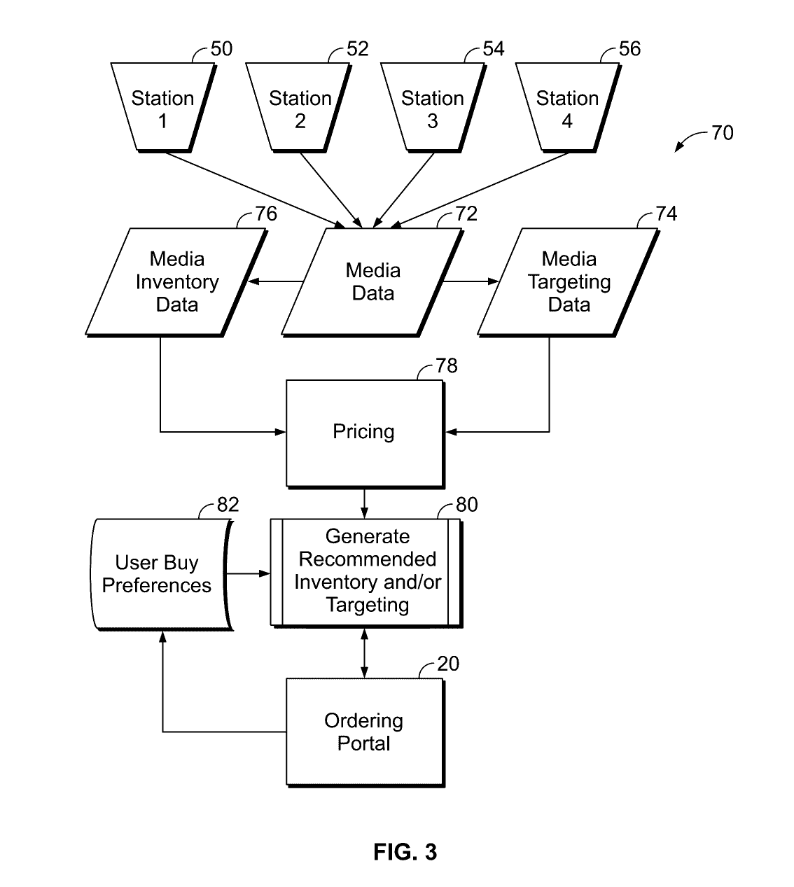

Turning to FIG. 1, the system 10 for production of customized media content, distribution and delivery of the customized media content is depicted. System 10 consists generally of an ordering portal 20 that is accessed by a user 12. The ordering portal 20 resource is generally a user-accessible graphical user interface (“GUI”) displayed on a computer connected to the Internet and linked to a Uniform Resource Locator or Web address that points to an IP (Internet Protocol) address or a domain name where the ordering portal 20 resource is located. The ordering portal 20 resource, which is more particularly described in FIG. 2, also optionally receives data from a media inventory and media targeting system 70, which is more particularly described in FIG. 3. During and after interacting with the user 12 to intake a media order, the ordering portal 20 resource outputs media order data for media order workflow management 30, where each media order is managed for production customization, media inventory selection, ordering and scheduling and media tracking selection, ordering. The media order workflow management 30 also manages the scheduling, transcoding 60, distribution and delivery 40 of the media order to each broadcast medium and broadcast station 50, 52, 54, 56 selected and identified in the media order. It will be understood by those skilled in the art that the foregoing description of the system 10 of the present invention is highly general and that it is contemplated that while four broadcast stations are depicted in FIG. 1, that at least one of a plurality of broadcast stations, from one to n, where n is an integer greater than 1, may be specified and ordered, depending upon the user-specified broadcast scope of the media order.

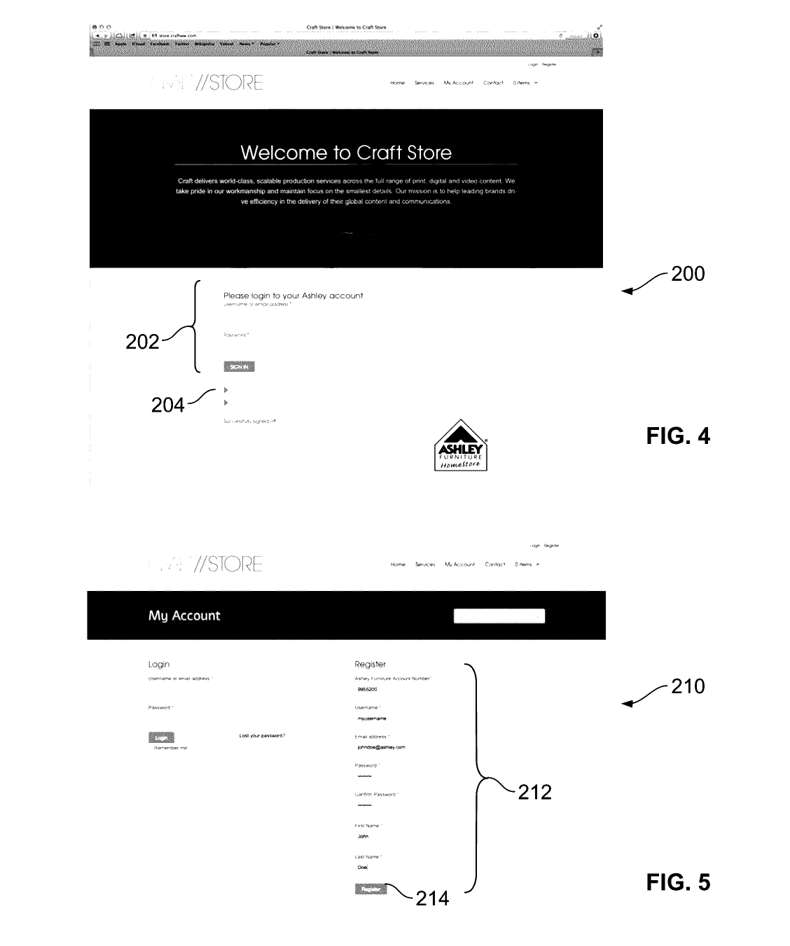

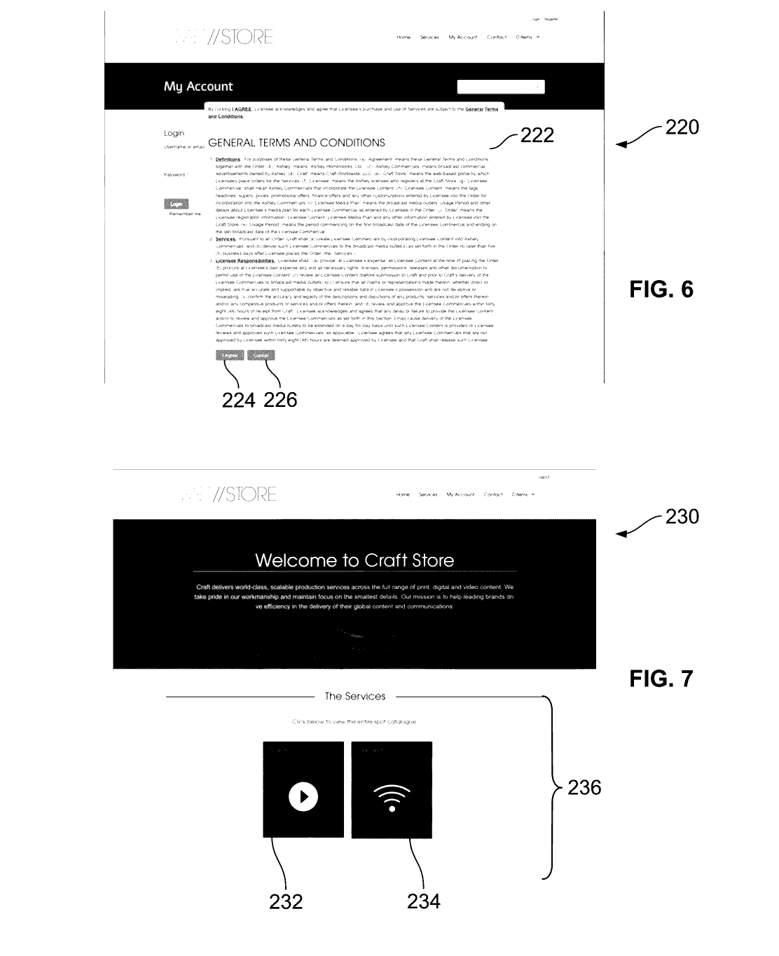

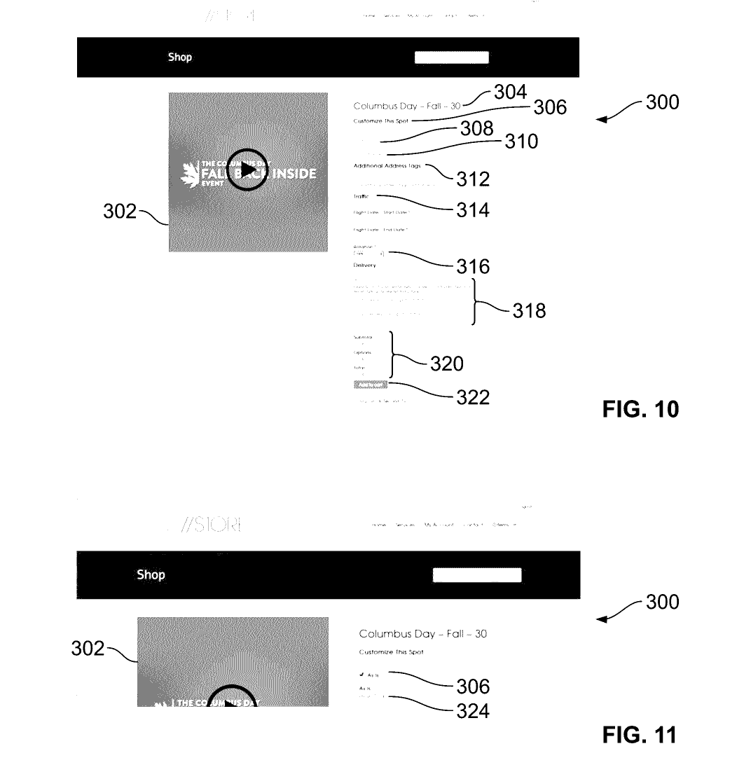

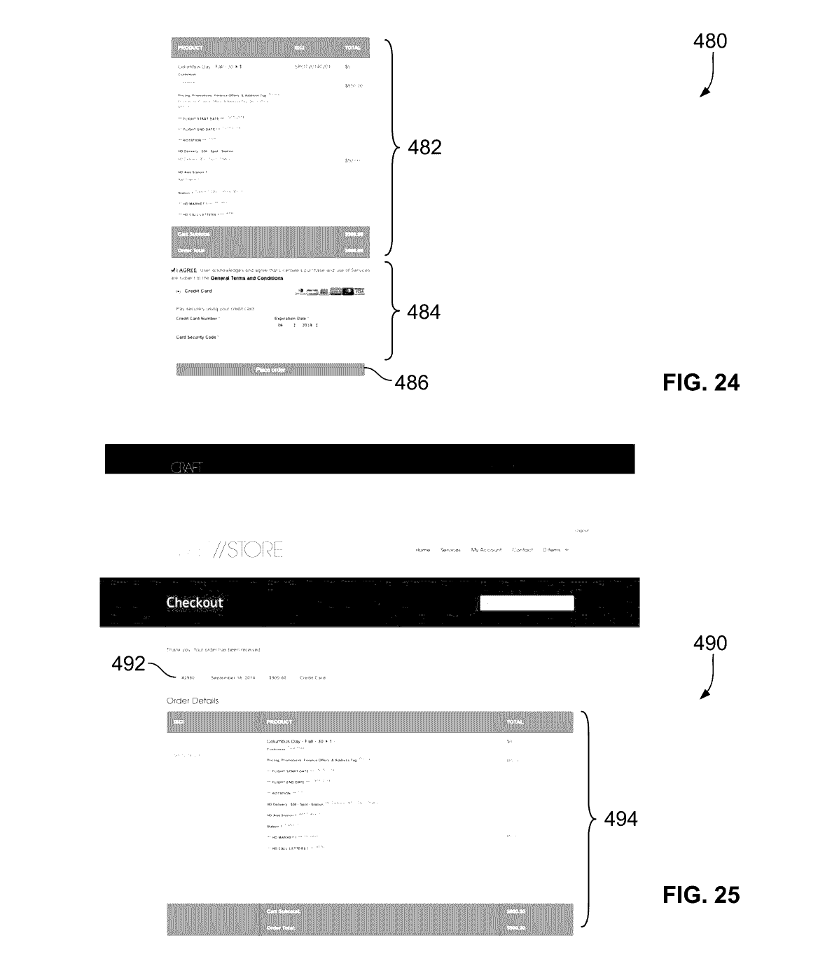

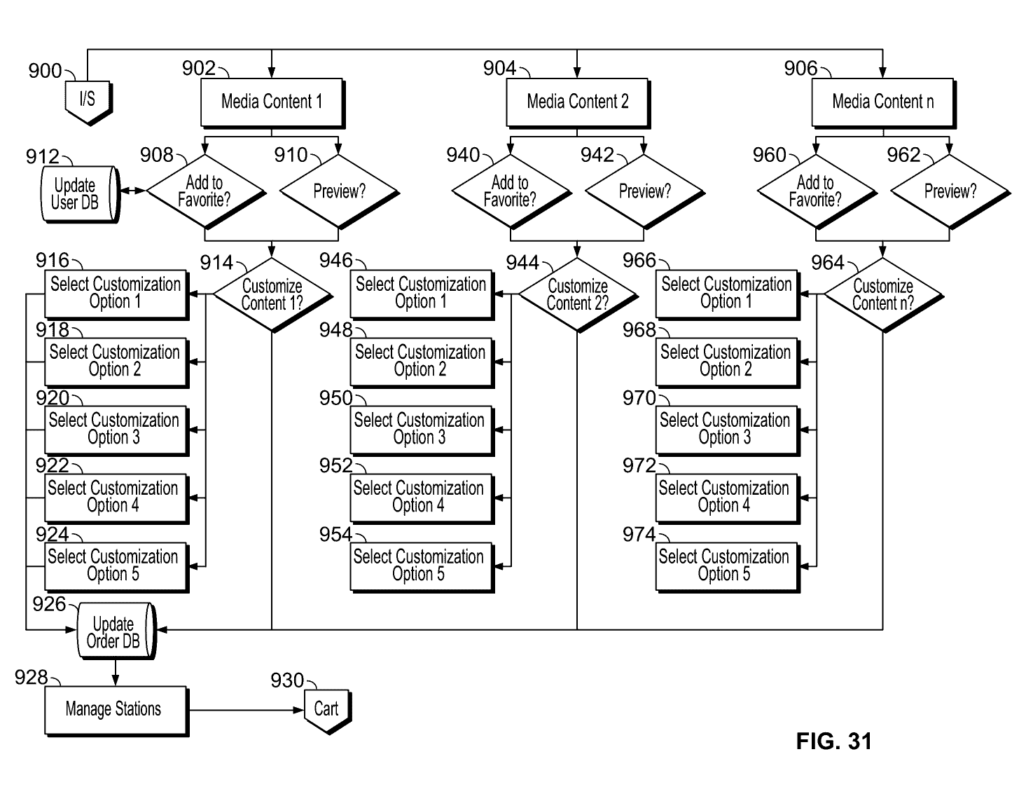

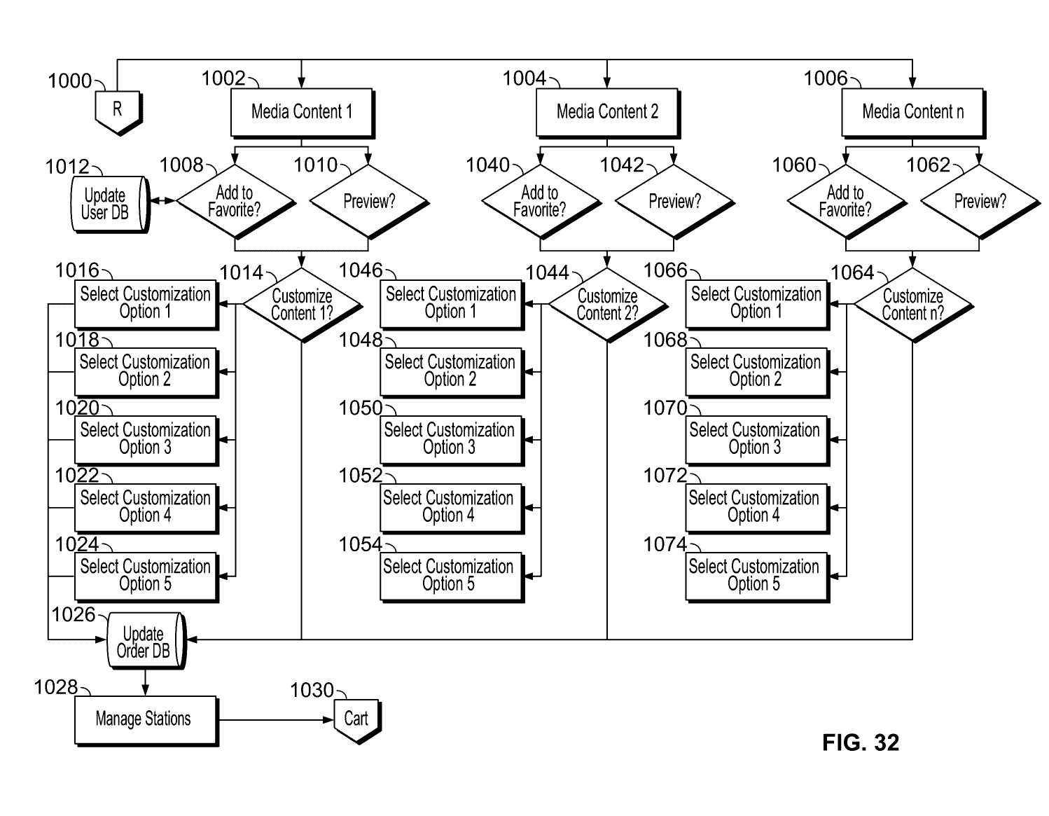

The operation of the ordering portal 20 resource is more specifically illustrated in FIG. 2. Ordering portal 20 resource consists generally of an ordering and production portion 80 and a distribution and delivery 40 portion. A media content order is initiated by a user or client 12 accessing and interfacing with a web-site hosted at a URL, such as https://www.spothub.com, 100. The process of making an media content order is described in greater detail hereinafter with reference to FIGS. 4-32. Once a media content order is received 102, a media content order database is updated 150 in the ordering and production portion 80 and a delivery date is saved 104 for fulfillment in the distribution and delivery portion 40.

Turning first to the ordering and production portion 80 of the ordering portal 20, upon updating the media content order database 150, a communication, such as an email, is sent 152 to the user/client 12 confirming the media content order. The media content order is also sent 154 from the media content order database 150 to media content order fulfillment processing 156. A notification that the media content order is received at order fulfillment processing 156 is posted to a Reporting database 178 and a communication, such as an email, is sent 152 to user/client 12. From media content order fulfillment processing 156, a master file, containing the user-selected media content, and any production customization selected by the purchaser for the media content order, is read, updated if needed, and completed for fulfillment processing 158. The updated master file is then added to a Quality Control Watch Folder 160 for automated quality control 162 and/or manual quality control 164. The Reporting database is updated 166 with the quality control status from the automated quality control step 162 and/or the manual quality control step 164. Once the Reporting database is updated 166, a communication, such as email, is sent to the client/user for their review and approval 168. Using the system's GUI, the client 12 will access the modified media content 170 for approval 172. If user 12 does not approve the modified media content the system 10 presents a change order form 176 to the client/user, which, when the client/user completes by indicating the changes desired or required and the change order is returned back to the media order fulfillment processing 156 for order fulfillment with subsequent updating of the changed media order master file, updating the watch folder for quality control and quality control processing as described above, until the user/client 12 approves 172 the changed media content.

Once the user/client 12 approves 172 the changed media content, the changed media content file is sent to a delivery watch folder 174 and the delivery watch folder 174 is updated and is sent to a content agent for transcoding 109 with an appropriate CODEC for each broadcast medium and broadcast station selected by the user/client 12.

Returning to the Distribution and Delivery portion 40 of the ordering portal 20, once the delivery date for the ordered media content is saved 104, the reporting database is updated with the client requested delivery date 108 and the media content master file is sent for transcoding 109. Transcoding may be performed using commercially available media workflow resources such as CONTENTAGENT (ROOT6 Technology, London, U.K.), VANTAGE (Telestream, Nevada City, Calif.) or EPISODE (Telestream, Nevada City, Calif.).

After transcoding 109, a user order library entry is made 122 in an account management section of the system 10, updating the status of the ordered media content and the transcoded master file is prepared for delivery 110. Broadcast stations identified the media content order are read and a stations file for each identified broadcast station is downloaded and the reporting database is updated 114. The reporting database is also updated with confirmation of delivery to the selected broadcast stations 116, and a communication, such as email is sent to the client 118 with notification the media content has been delivered to the selected broadcast stations 110.

Returning to the order received step 102, a resource for validating user-selected broadcast stations is provided. Once the order for media content is received 102, broadcast station IDs (described below) are read from the order and compared to a broadcast station definitions database 106. When known broadcast station IDs are matched to broadcast station definitions in the broadcast station definition database, the media content order is passed to the reporting database for client-requested delivery date updating 108. Where, however, an unknown broadcast station ID is present in the media content order 124, the system communicates, such as by email or other messaging modality, with a trafficker 126 that either places the broadcast station identifier from the media content order with a third party 128 for generation of a broadcast station definition or CODEC or directly obtains the broadcast stations definition or CODEC 130. The trafficker then coveys 132 the obtained broadcast station definition or CODEC for the broadcast station ID in the media content order to the transcoder where the broadcast station database is updated 116 with the new (previously unknown) broadcast station ID, station definition and CODEC for that broadcast station.

The media inventory and media targeting sub-system 70 is graphically illustrated in FIG. 3. The purpose of the media inventory and media targeting system is to individually or collectively facilitate identification and purchasing of media time from available media inventory and/or targeting the media content delivery to targeted media channels, markets and/or audiences. Media inventory data is acquired 72 from a plurality of broadcast stations, for example stations 1-4, 50, 52, 54, 56. The media inventory data, also known in the industry as “avails,” may include, among other things, available time slots, time slot duration, broadcast station, geographical market identification, pricing, distribution plan for the inventory, or like. Media targeting data is also acquired 74 from the broadcast stations, for example stations 1-4, 50, 52, 54, 56. The media targeting data may include, among other things market definition, market scope, consumer demographics, geographic market demographics, consumer lifestyle behavior, consumer response rate data, real time sales information or the like.

The media inventory and media targeting sub-system 70 then assigns pricing to the media inventory data 76 and/or the media targeting data 74, generates a recommended inventory buy or targeting buy to the client/user 80 based upon user buy preferences 82 and or user buying history received from the ordering portal 20 and the user/client management information retained within system 10.

Turning now to FIGS. 4-27, the operation of the system 10 and method of the present invention are illustrated with reference to GUI screen shots from an exemplary embodiment of the invention. It is expressly intended and contemplated that the GUI screen shots, the arrangement and selection of the illustrated data fields, menu selections, and the cascading or nesting arrangement of the data fields and screen displays is for purposes of example only and is not intended to limit the nature or scope of the invention. The arrangement and appearance of the data fields, menu selections or the cascading or nesting arrangement of the data fields and screen displays is considered to be variable and within the ordinary skill of one in the art to design and implement consistent with the invention defined in the appended claims.

The system 10 and method of the invention is initiated by a user accessing and interfacing with a web-site hosted at a URL, in this case https://store.craftww.com, that points to https://craftstore.spothub.com. A login screen 200 is displayed to the user with fields for a username or email address and a password 202 for registered users. For unregistered users, an option to register 204 is presented. FIG. 5 illustrates a screen shot of a user registration screen 210 having a plurality of registration data fields 212, including, for example, username, email address, password, password confirmation, first name, last name and a license or authorization number. Other fields, such as, for example, company name, company address, personal address, mailing address, phone numbers, website, social media user names, such as those on FACEBOOK, TWITTER, GOOGLE+, PINTREST, YOUTUBE, etc. may also optionally be included in the registration data fields 212. Once the required registration data fields 212 are validated by the system 10, an input button 214 for activating the registration is made active to the user. Activating the input button 214 initiates user registration process in which a user database entry is created and a user database resident on a server is updated with the new user data.

Once registered, the user is presented with an end user license agreement (“EULA”) 222 on screen 220 and prompted to accept or reject the terms and conditions of the EULA, by activating both an acceptance input button 224 and a cancel input button 226. In response to user selection of the acceptance input button 224, the system 10 presents the user with a medium selection screen 230. In response to a user selection of the cancel input button 226, the system returns the user to the initial login screen 200 or logs the user out of the system 10 entirely.

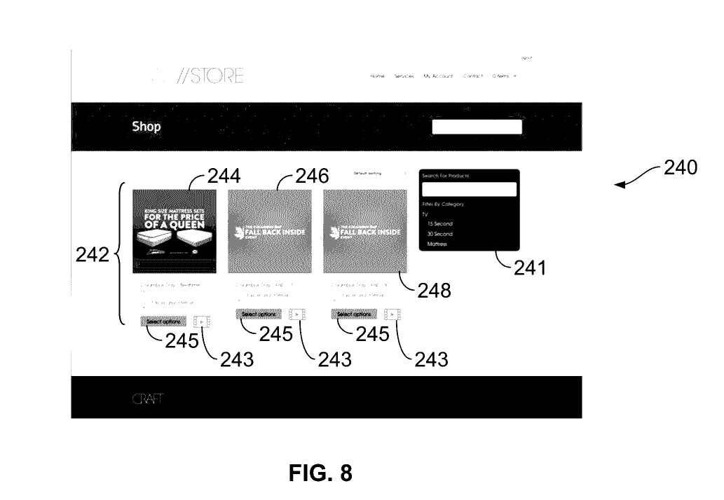

The medium selection screen 230 presents a selection of a plurality of broadcast medium services 236, in this case television 232 and radio 234. Each selection may be a hyperlink and/or an input button in the webpage that is selected by the user. It will be understood by those in the art that other broadcast medium services 236 may also be presented for selection by the user, including, without limitation, print, satellite, streaming media, Internet, webcast, podcast or the like. Selection of a particular broadcast medium 232, 234, points to a cascading set of user interface screens presenting the user with a series of customization, ordering and checkout options. For purposes of illustration in the following FIGS. 8-27, we assume that the user has selected the television button 232, however, the operation and method of system 10 is substantially the same regardless of the broadcast medium selected by the user.

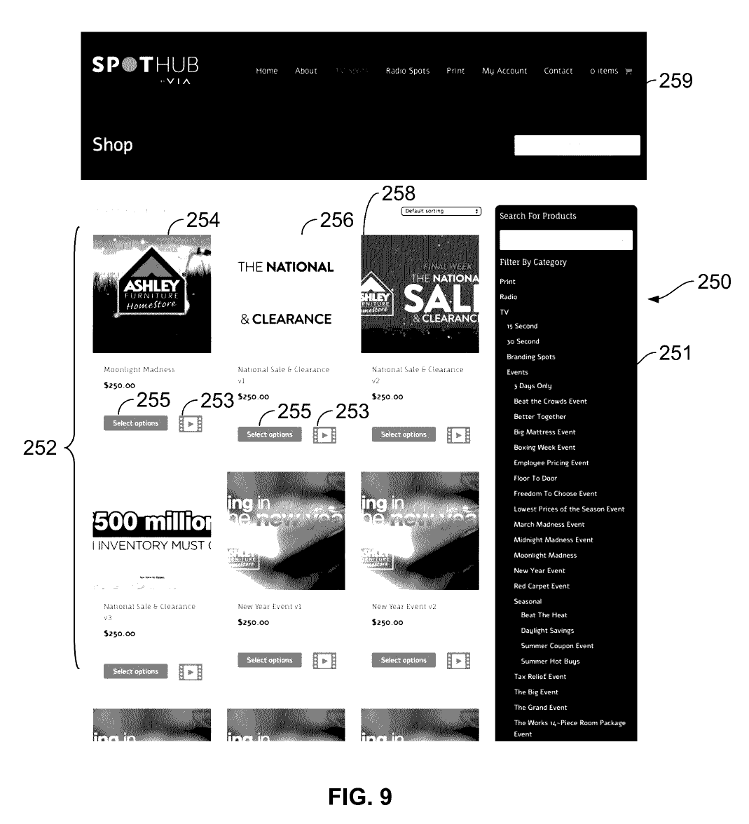

Once the medium selection button 232 is selected by the user, the system 10 presents a media content selection screen 240 to the user. Media content selection screen 240 includes a plurality of media content selection buttons 244, 246 and 248, each representing a pre-produced media content template for an advertising spot and a search resource 241 for entering search criteria to identify particular media content. Associated with each media content selection button are a select options button 245 and a preview button 243. The select options button 245 cascades to a plurality of customization options presented in other screens to the user. The preview button 243 displays the media content on the users screen for previewing by the user. FIG. 9 illustrates another embodiment of a GUI screen displaying a plurality of media content selections 252, each media content having a media content selection buttons button 254, 256, 258, with each media content selection button having a select option button 255 and a media content preview button 253. Like the embodiment depicted in FIG. 8, a search resource 251 is provided, as is a main menu selector 259 to navigate the website.

After selecting a media content selection and activating the select options button 245, the system invokes a first media content customization screen 300 for the selected media content. The first media content customization screen 300 presents to the user a window 302 with the playable media content selected by the user, and a plurality of user selectable customization options to customize the selected media content. A media content title 304 is displayed, together with a first customization option that prompts the user to select a no customization option 306 or a customization option 308. An additional customization option is provided to select additional address tags 312 be added to the media content.

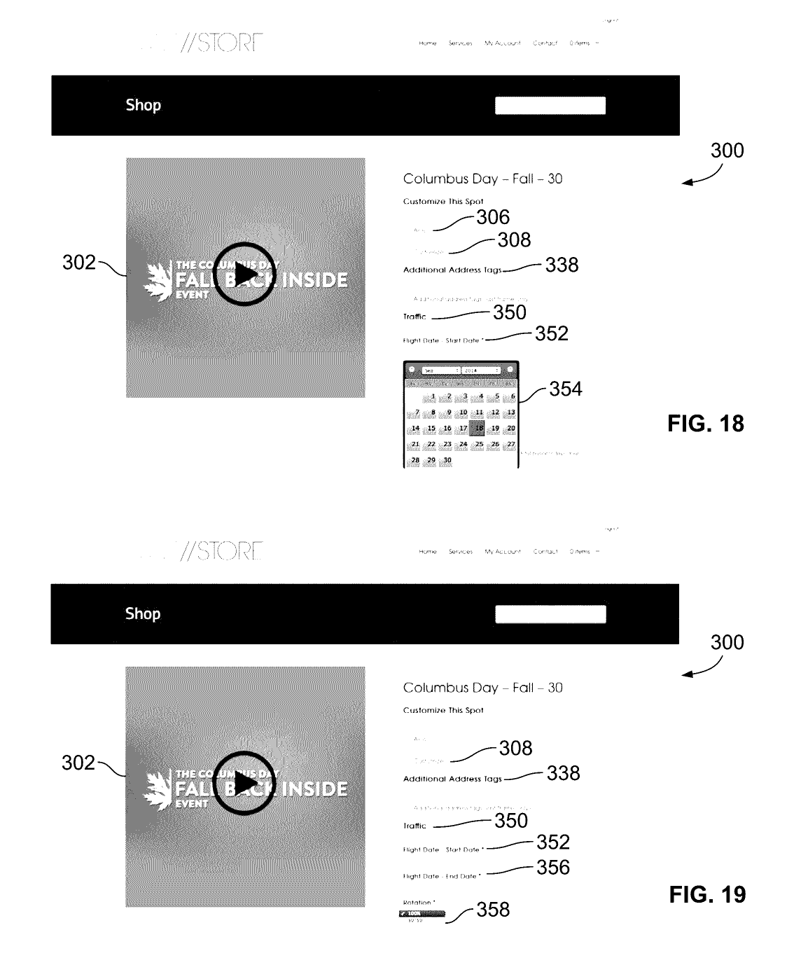

Media traffic options are presented to the user including the flight start date and the flight end date options 314 and an ad rotation 316. The user specifies the flight start date and end date either by direct entry of dates or by pop-up calendar 354 as illustrated in FIG. 18. The ad rotation option 316 may be selected through a drop down list of rotation sequencing options 358 in FIG. 19.

Media delivery options 318 are also presented to the user, which prompt the user to select high definition format or standard definition format.

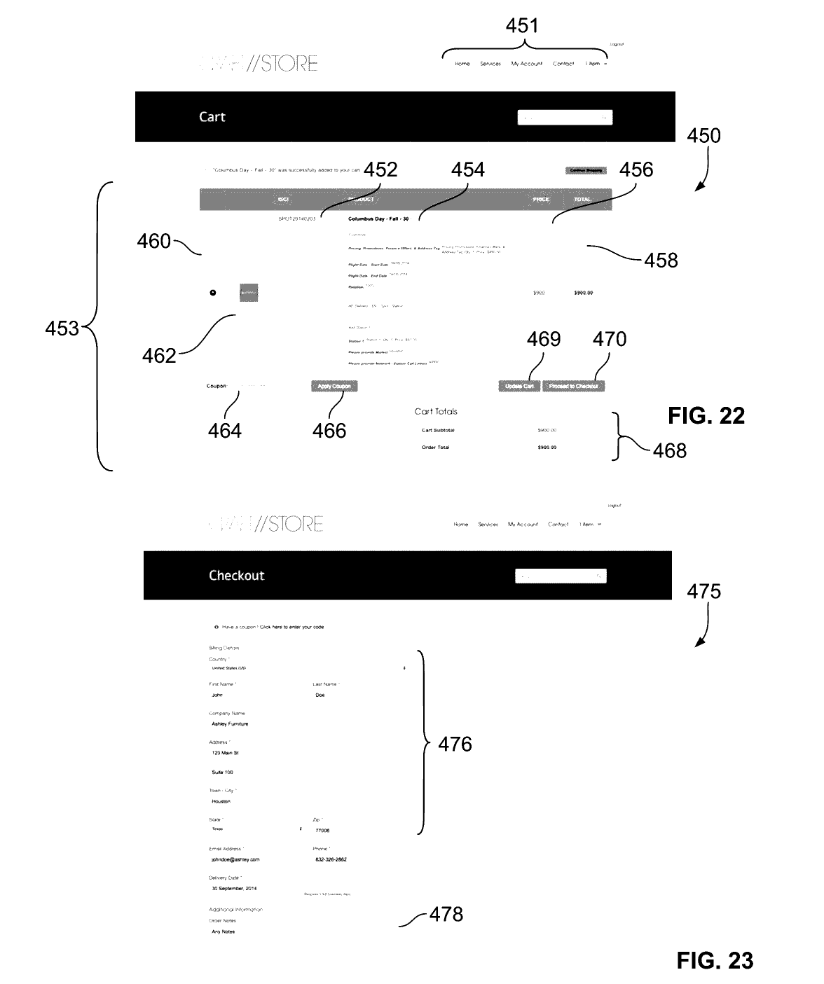

Pricing information 320 is calculated on the basis of the media content selected, the user selected options described above and then subtotaled and totaled for the user. Finally, an ordering button 322, in this case labeled “add to cart” is presented to the user to post the order to the user's shopping cart for subsequent checkout and purchasing as illustrated and described hereinafter with reference to FIGS. 22-25.

If the user selects the no customization option 306, as in FIG. 11, the pricing of the media content is displayed in the pricing information field. When activated by the user, the ordering button 322 (not shown in FIG. 11), the order is posted to the shopping cart for subsequent checkout and purchasing.

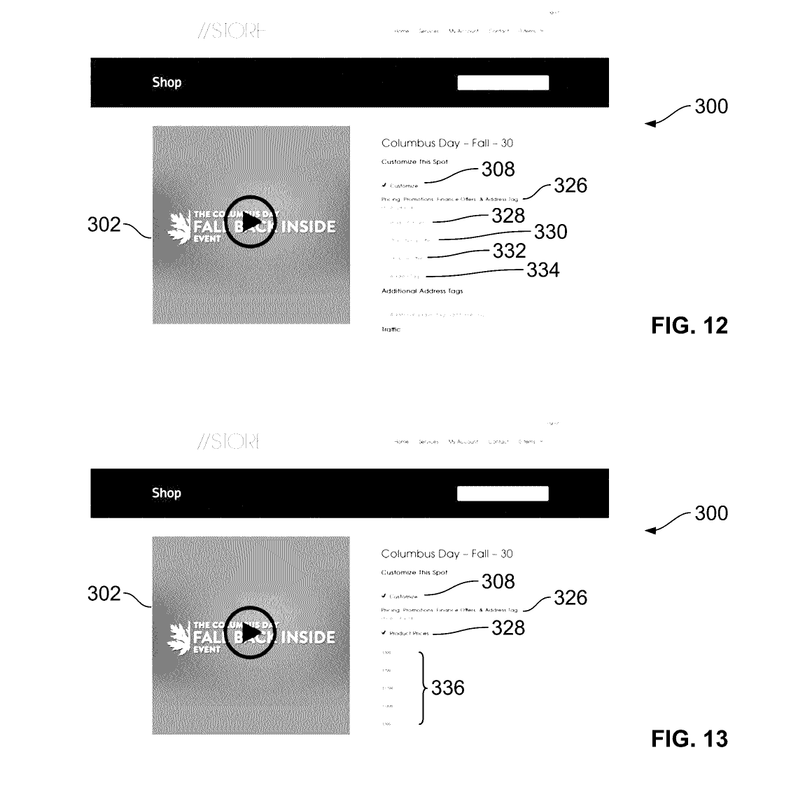

When the user selects the customization option 308, as shown in FIG. 12, the system 10 presents a plurality of customization options, including, for example, product pricing option 328, promotional offer option 330, financing offer option 332 and address tag option 334. Each of the plurality of customization options is independently user selectable. Upon selection of each customization option 328, 330, 332, 334, the pricing information 320 is calculated and displayed to the user 326. As each customization option is selected, it individually cascades a plurality of customization sub-options related to each customization option 328, 330, 332, 334.

FIG. 13 illustrates a plurality of product pricing sub-options 336 that cascade when the product prices option 328 is selected. The plurality of product pricing sub-options 336 may be a plurality of blank fields for user entry, a plurality of drop down lists for user selection, pre-populated fields, each independently selectable by the user, or other similar data field presentations that permit the user to select one or more of the plurality of product pricing sub-options 336. As illustrated, the product pricing sub-options are user entry fields, and product prices are entered by the user, however, as noted above, it is expressly contemplated that other means of user selected data entry or pre-populated data fields are included in the scope of the present invention.

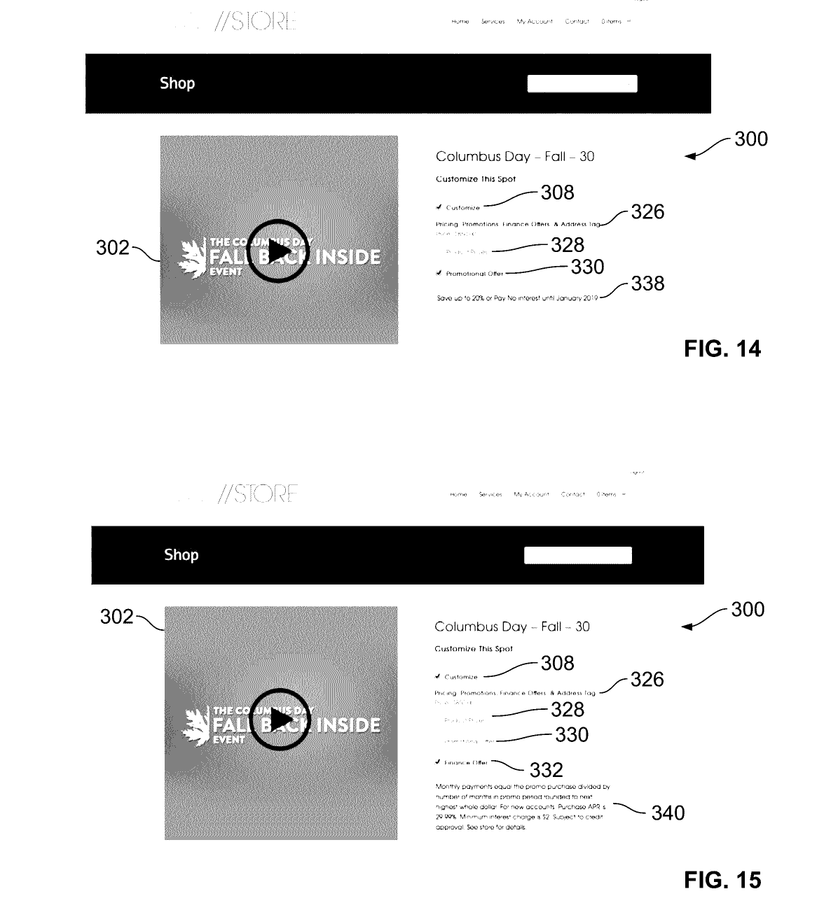

FIG. 14 illustrates a promotional pricing sub-option 338 displayed as a user prompt when the user selects the promotional offer option 330. Again, while a single text entry field 338 is illustrated in the present example that allows a user to enter any desired promotional pricing or promotional offers for customization into the selected media content, plural text entry fields, plural data entry fields, plural pre-populated fields, drop down lists or the like are similarly contemplated as a means for presenting the at least one of a plurality of sub-options 338.

FIG. 15 illustrates the media customization screen display 300 with a finance offer sub-option 332 selected by a user. Like the promotional pricing sub-option 338, above, the finance offer sub-option 332 is presented as a single text entry field 340 for illustration in the present example that allows a user to enter any desired promotional financing offers for customization into the selected media content. Plural text entry fields, plural data entry fields, plural pre-populated fields, drop down lists or the like are similarly contemplated as a means for presenting the at least one of a plurality of sub-options 340.

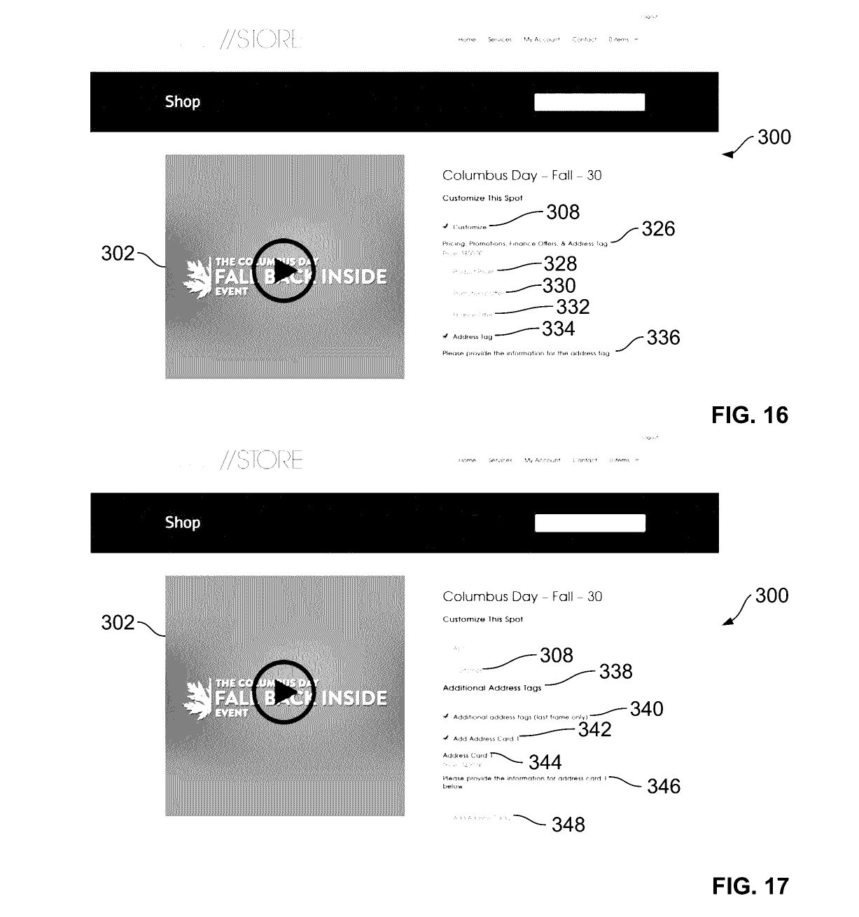

FIG. 16 illustrates the media customization screen display 300 with an address tag sub-option 334 selected by a user. Like the promotional pricing sub-option 338 or the finance offer sub-option 332, the address tag sub-option 334 is presented as a single text field 336 for illustration in the present example that allows a user to enter any desired address tags for customization into the selected media content. Plural text entry fields, plural data entry fields, plural pre-populated fields, drop down lists or the like are similarly contemplated as a means for presenting the at least one of a plurality of sub-options 336.

FIG. 17 illustrates an additional user selectable address card sub-option 342 to the additional address tag option 338. An address card in the advertising industry is a direct mail advertising piece mailed to households within the advertising spot's target audience. In the present system, the address card option 342 is user selectable and, when selected, displays the pricing 344 of the address card option 342 and opens a address card data field and prompt 346 for the user to provide information for the address card. While the address card sub-option 342 is shown in FIG. 17 as a single text entry field that allows a user to enter any desired address card information to the media content order, it will be understood that plural text entry fields, plural data entry fields, plural pre-populated fields, drop down lists or the like are similarly contemplated as a means for presenting the at least one of a plurality of address card sub-options 346. A second address card sub-option 348 or more address card sub-options 348 may be presented to the user in a cascading manner depending upon which address card sub-options 342, 348 are user selected.

Turning to FIGS. 18-19, the media customization screen display 300 is illustrated with the traffic option 350 presented to the user for completion. All media content orders must have a beginning flight date 352 and an ending flight date 356. The flight start date field 352 and the flight end date field 356 are date fields and may be user entry fields, calendar entry fields with pop-up calendars 354 (as illustrated in FIG. 18) or may be automatically calculated based upon user specification of a beginning flight date 352 and a number of days for the flight to run. Finally, the traffic option 350 includes a rotation sub-option 358 in which the user will specify the rotation scheduling for the media content broadcast. The rotation may again be a text entry field for user entry, or may be a drop-down list of options, as depicted in FIG. 19.

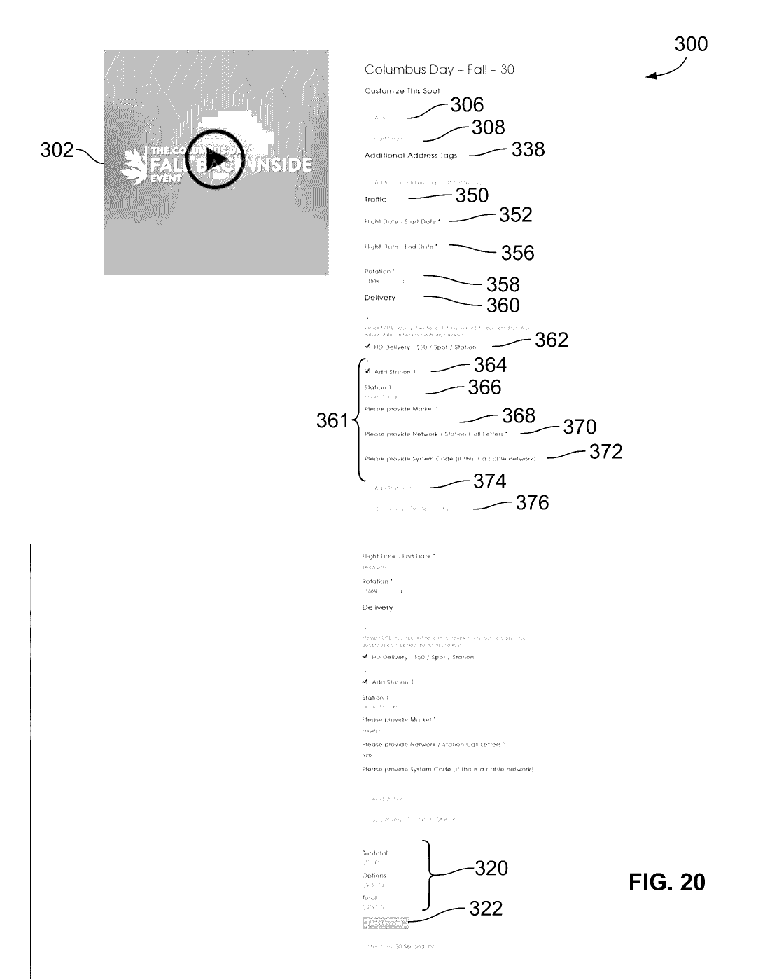

FIG. 20 illustrates the media customization screen display 300 presenting the foregoing sub-options and traffic options, and delivery options 360 for the media content ordered. The delivery option 360, as noted above, includes sub-options for high definition delivery 362 or standard definition delivery 376. When the high definition delivery sub-option 362 is selected by the user, a first plurality of station prompts 361 are presented to the user. The first plurality of station prompts 364 for entry of a first station, displays pricing for the first station 366 and then presents a market entry prompt 368 that prompts the user to enter or select a market covered by the broadcast station selected, then prompts the user to enter the broadcast network or station call letters 370 and/or the System Code for a cable network 372. Again, while each of the market entry prompt 368, prompt for broadcast network or station call letters 370 and/or the System Code prompt for a cable network 372 are depicted, for illustration, as text entry fields, each of the data fields for each of these prompts may be selected from drop down lists, pre-populated fields, menu-searchable and/or accessible lists, or the like are similarly contemplated as a means for user entry of data into each of the prompted fields.

Prompts 374 for additional stations 2-n, with n being an integer greater than 2, for delivery of the media content are also provided, each of which, when selected by the user, cascade market entry prompts 368, broadcast network/station call letter prompts 370 and/or System Code prompt for a cable network 372.

If the user selects the Standard Definition format delivery prompt 376 for delivery of the media content, again a cascade of market entry prompts 368, broadcast network/station call letter prompts 370 and/or System Code prompt for a cable network 372 is presented to the user as described above.

Once the user has completed entering all delivery information, the pricing fields 320 are updated and displayed for the user, and the ordering button 322, in this case labeled “add to cart” is presented to the user to post the order to the user's shopping cart for subsequent checkout and purchasing as illustrated with reference to FIGS. 22-25.

When the ordering button 322 (labeled “add to cart”) is selected, the system 10 presents a shopping cart screen 450 to the user on the user's GUI display. Shopping cart screen 450 is constructed with a menu 451 that allow the user to navigate to a plurality of system resources and tally orders in the cart. A current order window 453 displays a table with current order information displayed, including, for example, an Industry Standardized Commercial Identifier (ISCI) code 452, an identification of the product 454, the product price 456 and the product order total 458 for the ordered media content. The table in the current order window 453 may also include a link to the ordered media content 462 or an order line item delete button 460 that enables the user to delete the order line item. A coupon entry field 464 and a coupon entry button 466 prompt the user to enter any coupon or discount codes that will alter the pricing of the ordered media content. An update cart button 469 is provided to refresh the table in the current order window 453 when changes to the table in the current order windows 453 are made by the user.

A cart totals window 468 is updated based upon the pricing in the product pricing field 456 and the product order total field 458 in the table in the current order window 453, and is updated when the update carton button 469 refreshes the table in the current order window 453.

Finally, a checkout button 470 finalizes the order and opens a checkout screen 475 on the users GUI display. Checkout screen 475 prompts the user to enter alphanumeric information into a plurality of billing and delivery fields 476, including for example, name, address, email address, phone number and delivery date information, and also prompts the user to enter by a text entry into an additional information 478 field, that the user wishes to convey to the system 10 host.

A payment entry window 480, that may be part of the checkout screen 475 or may be a cascading screen displayed once required information is entered into the checkout screen 475, displays ordered media content information table 482 and prompts the user to enter payment information 484, such as credit card payment information as is known in the art. Finally, a place order button 486 prompts the user to process payment for the order and finalize the order. Once the place order button 486 is selected, an media content order confirmation screen 490 is displayed on the users display GUI displaying media content order information 492 including, for example, fields containing an order number, order date, order pricing, and payment method. The media content order confirmation screen 490 also preferably displays an order detail table 494, confirming the ISCI, product and pricing totals for the media content order to the user.

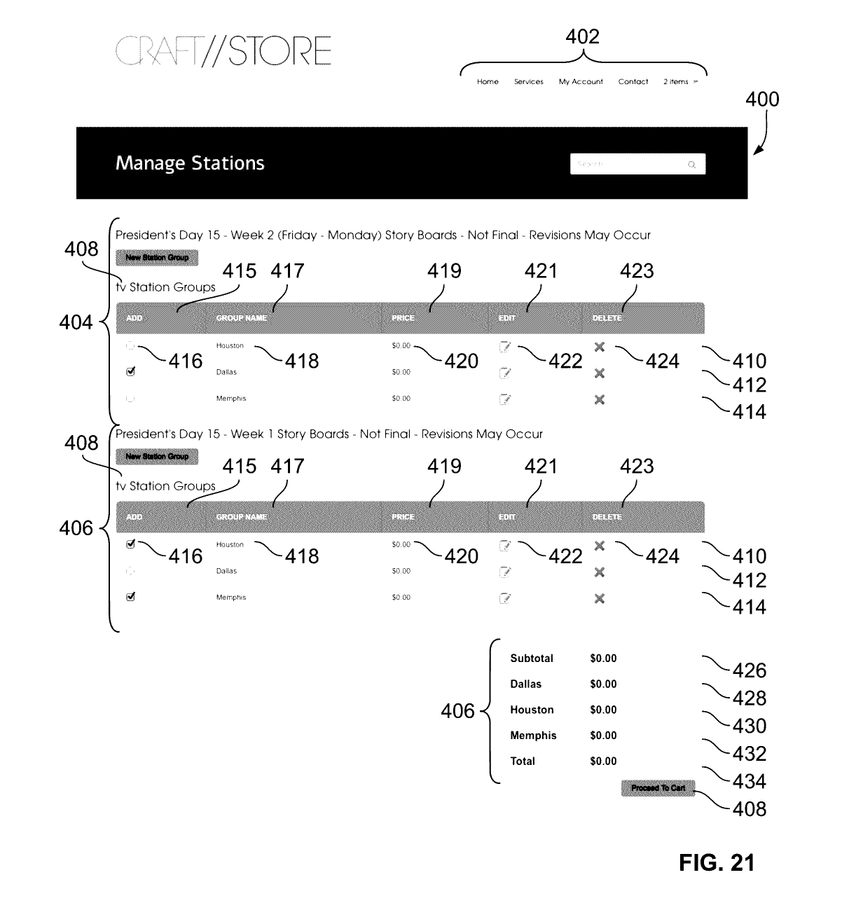

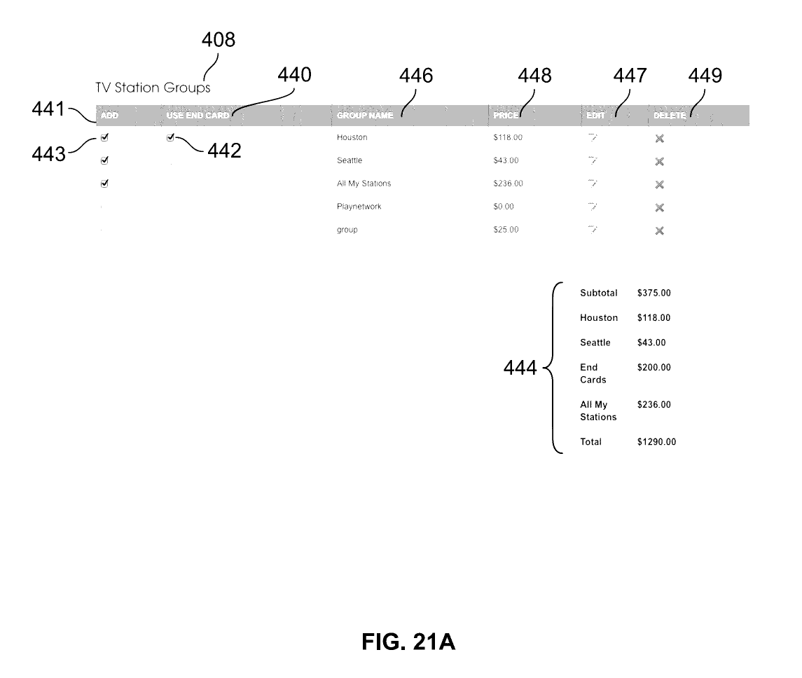

Turning now to FIG. 21, a manage stations screen 400 is depicted. The manage stations screen is a resource that reads from a user media content selection the user's broadcast station selections and the users selected broadcast stations for each media content order. Broadcast station groups 408 are groups of broadcast stations having a user-defined. The user defined relationship may be geographic, as reflected in the city or market names 418, i.e., Houston, Dallas, Memphis, or Northeast, Midwest, South, Pacific coast, Southern California, or the like. Alternatively, the broadcast station groups 408 may have other orders of relationship, such as broadcast medium type, i.e., television network, streaming media, Internet, radio, cable, satellite, by cost structures, i.e., groupings by cost per unit time, by targeting data, i.e., average response rate, or other such orders of relationship meaningful to the user.

The manage stations screen 400 presents a navigation menu 402 to the user that contains a current shopping cart order status button and a plurality of media content order fields 404, 406, with each media content order field displaying a single media content order and a broadcast station group 408. Each broadcast station group 408 is a table or a window with a plurality of broadcast station group selection options 410, 412, 414. Once the plurality of broadcast group selection options 410, 412, 414 are selected/entered by the user for a given selected media content, a variety of other options are also available to the user for review, editing, deletion or selection.

The additional broadcast station group selection options, may include, for example, a broadcast station group name 417, which may be a geographical market name, e.g., Houston, 418 or another identifier of a market or group of broadcast stations, a pricing field 420 for the broadcast station group name 417, an user selectable add option 416, an edit option 422 and a delete option 424. The manage stations screen 400, optionally, may have a pricing summary window or table 406 that includes a plurality of pricing itemization fields 426, 428, 430, 432,434, comprising, for example, a station group sub-total field 426, a first 428, a second 430 and a third 432 broadcast station group sub-total fields, each of the plurality of broadcast station group sub-total fields reads pricing data from the pricing field 420 and calculates a total from each of the plurality of media content orders 404, 406. Finally, the pricing summary window or table 406 may have a pricing total field 434 that sums each of the other plurality of fields in the pricing summary window or table 406. A selection button 408 (labeled, for example, “proceed to card”) finalizes station management and updates the user selections to a user station database (not shown).

The manage stations 400 screen is independently accessible from a home screen menu 402 and may be accessed by the user to be an entry point for managing the user's broadcast station groups 408. Thus, the manage stations functionality will not only read from a given user media content order, but serves a management function for the user to establish, organize, maintain and access the users broadcast station groups 408 for multiple media content orders.

FIG. 21A illustrates an alternative embodiment of a broadcast station group that includes a “use end card” field and a user selector 442 wherein the user can select whether to use the ad spot end card for purpose of broadcast station selection with the broadcast station group. The ad spot end card, conventionally, is an address tag or includes address tag information in a static or motion graphic of the ad spot. Selecting the “use end card” option 442 prompts the system to distribute the ad spot within a predetermined set of user-specified broadcast stations within the broadcast station group selected by the user.

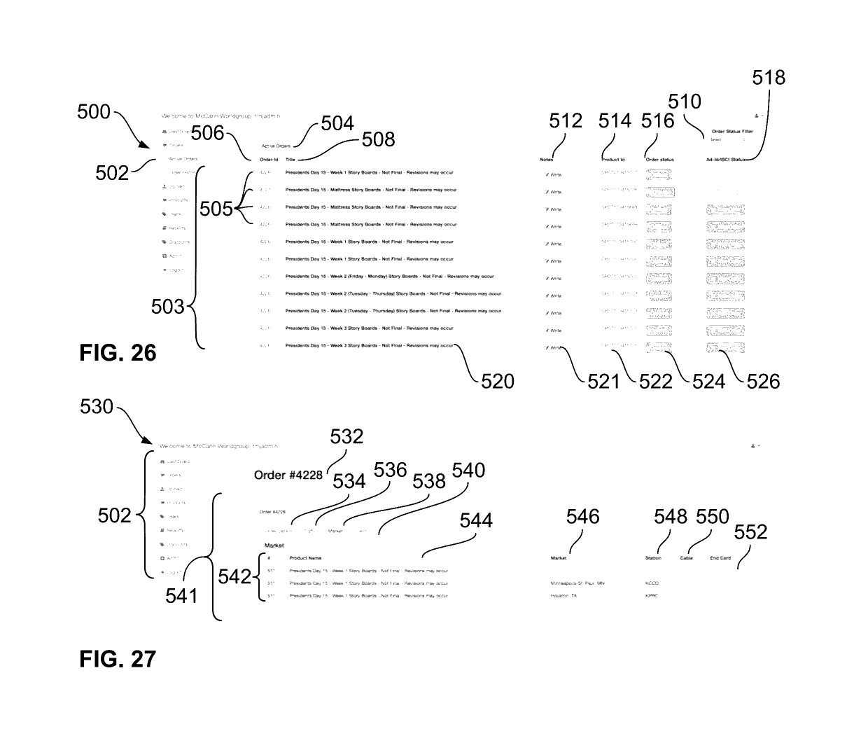

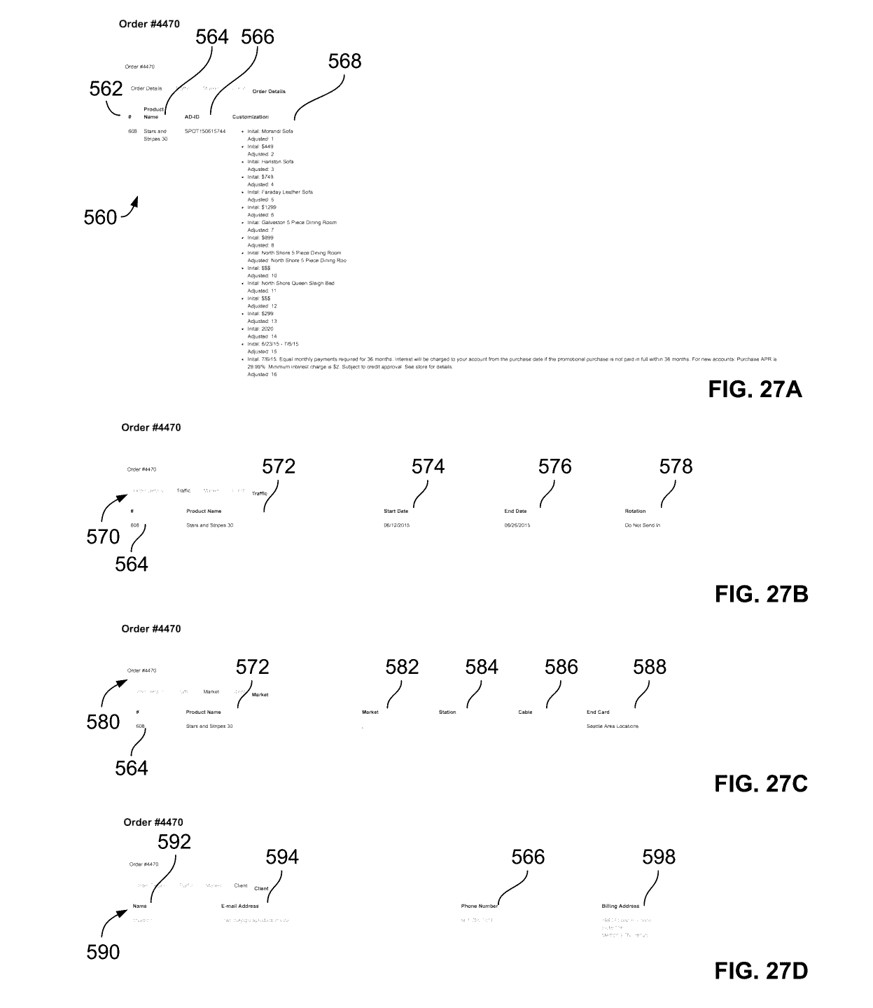

FIGS. 26 and 27 illustrate an active orders screen 500 and an individual active order screen 530, respectively. The active orders screen 500 may include a navigation menu 502 with a plurality of page navigation buttons that allow the user to move between a plurality of Web-pages on the hosted system 10 site. An order table or window 504 is provided in which a plurality of open orders 503 are displayed, each of the plurality of open orders 505 may include an order identifier 506, a media content title 508, a product identifier 514, an order status indicator 516 and a delivery status 518. A notes field 512 may, optionally, be provided. The notes field may allow for direct text entry or may be a selectable button 521 that opens a new window (not shown) that prompts the user to enter a textual message to the system 10 operator.

The product identifier field 514 may be any identification system desire by the system 10 designer or operator, however, it is preferable to that the product identifier 522 conform to the Ad-id/ISCI code conventions discussed above and as illustrated in FIG. 26.

The order status column 516 displays an active order status field 524 for each of the plurality of individual open orders 505. Each active order status field 524 either receives from or reads from the order database 150 (FIG. 2) the order status and displays the read or received order status information in the order status field 524. The order status field 524 may be may be a button that hyperlinks to open a new Web-page or window for the individual order status, such as individual order status window 530, or may be a dynamically labeled hyperlink button, where a text label on the button is dynamically updated based upon the order status read or received from the order database 150 (FIG. 2), the dynamic label may include alphanumeric labels, such as “ordered,” “in process,” “pending,” “completed,” or other such informational indicator of the status of the individual order.

The delivery status field 518 includes a status indicator 526 for each of the plurality of active orders 530. The delivery status indicator 526 may be an updatable field that reads order status from an order database 150 (FIG. 2), alternatively, the delivery status indicator 526 may be a button that hyperlinks to open a new Web-page or window for the individual order status, such as individual order status window 530, or may be a dynamically labeled hyperlink button, where a text label on the button is dynamically updated based upon the order status read or received from the order database 150 (FIG. 2), the dynamic label may include alphanumeric labels, such as “New Order,” “In transition,” “in process,” “pending,” “Client Review,” “Delivered,” or other such informational indicator of the status of the individual order. The delivery status field 518 indicates the delivery status of the commercial associated with the ordered media content identified by the corresponding Ad-id/ISCI code.

FIG. 27 illustrates the individual active order screen 530, in this case corresponding to Order ID 4228 from FIG. 26. Like the active orders screen 500, the individual active order screen 530 includes a navigation menu and a primary window or table 541. Table 541 has sections for the user to access order details 534, order traffic 536, order markets 538 and order client 540, each section displays a window or table having at least one of a plurality of active order status entries 542. As depicted in FIG. 27, order markets are displayed and include a product name 544, a market identifier 546, in this case geographical market identifiers such as “Houston, Tex.” and a station identifier 546, the station identifier containing the call sign for the broadcast station selected in the order, e.g., “KPRC.” A cable identifier 548 and an end card identifier 552 may, optionally, also be provided.

FIG. 27A illustrates a screenshot depicting exemplary order details 560 in which an order number 562 assigned to the media content order is displayed, a product name 564 identifies the ordered media content, the AD-ID code 564 for the ordered media content is displayed and a summary of the customization options selected by the user 568, including, without limitation, a description of the customization option and pricing, are displayed.

FIG. 27B illustrates a screenshot depicting exemplary order traffic 570 information in which the order number 564 is displayed, the product name 572, the start date 574, the end date 576 and the rotation 578 for the ordered media content are all summarized as traffic data for the user.

FIG. 27C is a screenshot depicting the order markets 580 for the selected media content order which includes, for example, the order number 564, the product name 572, the market 582, station 584, cable, if any, 586 and the end card information 588 from the ad spot, where either the “use end card” option 442 is selected from the manage stations function depicted in FIG. 21A or the user specifies otherwise that the end card is to be used for market distribution.

Finally, FIG. 27D is a screenshot depicts order client 590 information and includes ordering client information, such as, the client name or designator 592, an email address for the user 594, a user phone number 596 and a billing address 598 for the user.

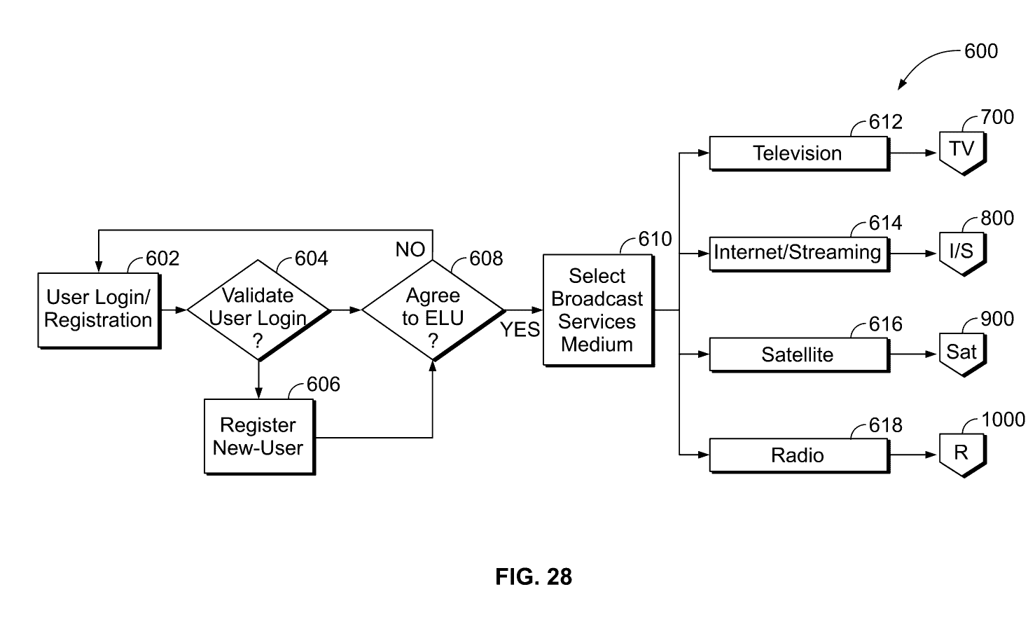

FIGS. 28-34 are flowcharts that illustrate the method of the present invention as represented by the series of the screen shots from FIGS. 4-27. FIG. 28 depicts the process represented by FIGS. 4-7, in which a user logs in or registers 604 with system 10, the system 10 validates the user login 604. A valid user login 604 will cause the ELUA to be presented on the user's GUI display 608, whereas an invalid user login 604 will ask the user to register 606, and upon registration, will present the ELUA screen to the user's GUI display 608. If the user agrees to the ELUA 608, the system presents the select broadcast medium screen 610, whereas if the user does not agree to the ELUA 608, the user is returned to the user login/registration screen 602 or logged out of the system 10 entirely. When the select broadcast medium screen is presented 610 on the user's GUI display, the user is prompted to select from one of a plurality of broadcast medium options, in this case television 612, internet/streaming 614, satellite 616 or radio 618. User selection of one of the broadcast medium options, cascades processing toward a corresponding set of routines depending upon which broadcast medium option is selected. Thus, selection of the television broadcast media option 612, cascades a TV process 700, selection of the internet/streaming broadcast media option 614, cascades the internet/streaming process 800, selection of the satellite broadcast medium option 616, cascades the satellite process 900 and selection of the radio broadcast medium option 618, cascades the radio medium option 1000.

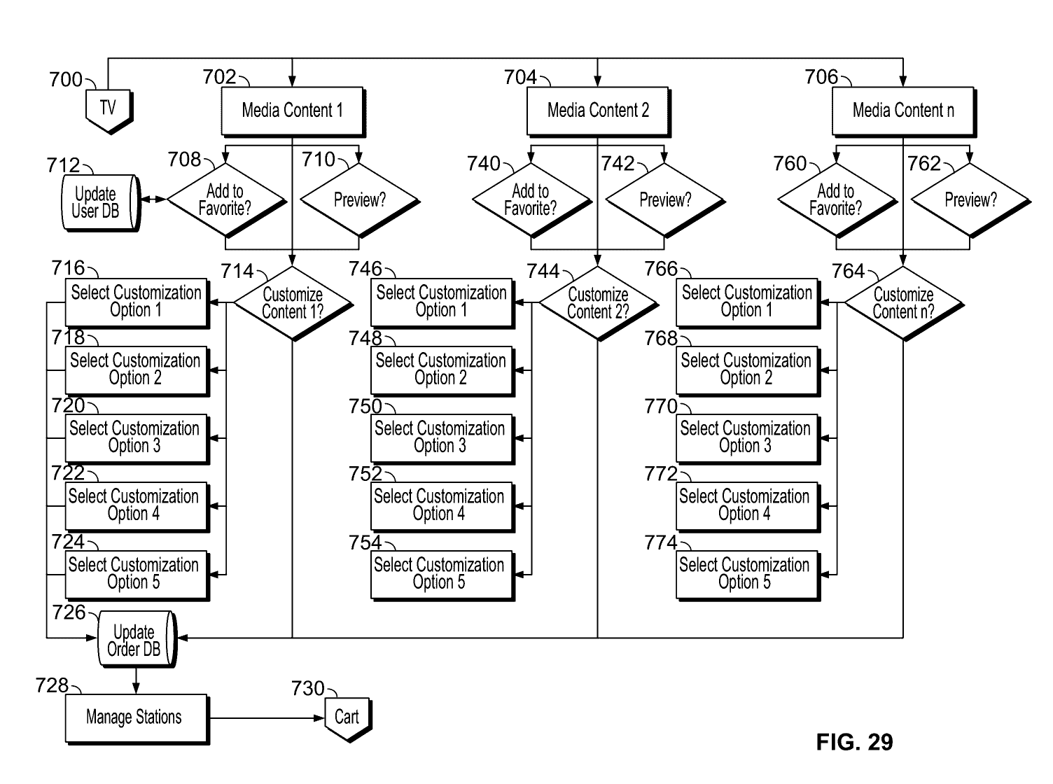

FIG. 29 is a depiction of the process flow of media content selection and customization when the TV medium option 700 is selected. A plurality of media content options, including media content 1, 702, media content 2, 704 to media content n, 706, where n is an integer greater than 2, are presented to the user on the users GUI display. The user is prompt to select at least one of the plurality of media content options 702, 704, 706. For each of the plurality of media content options 702, 704, 706 selected by a user, there is a cascade of a plurality of customization options presented to the user on the user's GUI display.

For purposes of illustration we assume that the user selects media content 1 702. A first decisional prompt queries the user to add the media content 1 702 to a list of favorites 708. If the add to list of favorites is selected, the user database 712 is updated by designating media content 1 702 as a favorite. The user is also presented with a decisional prompt that queries the user to preview 710 media content 1 702 on the user's GUI. Optionally, the user database 712 may be updated by designating or counting that the media content 1 702 record has been previewed. The number of previews may, optionally, be counted and maintained in the user database 712. Alternately or sequentially relative to the add to favorites prompt 708 and/or the preview prompt 710, a third decisional prompt to customize media content 1 702 is given to the user. An affirmative answer to the customize media content 1 prompt 714 cascades a series of media content customization options, denoted Customization Option 1, 716, Customization Option 2, 718, Customization Option 3, 720, Customization Option 4, 722 and Customization Option 5, 724, each of which is independently selectable by the user. Optionally, each of the plurality of media content customization options may further cascade a plurality of media content sub-options for that allow for customization of the media content. Each of the plurality of media content customization options, upon selection and updating by the user, update the user order database 726 with the media content customization selections made by the user. A negative user response to the third decisional, i.e., the option to customize the media content, will update the order database 726 with the non-customization option selected by the user.

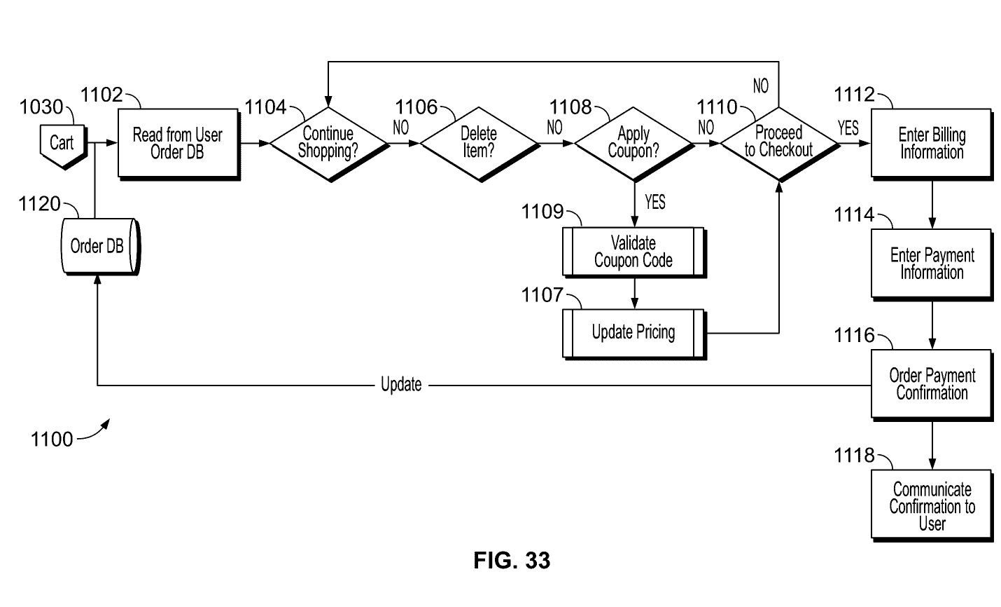

Upon completion of the media content customization options, and, if any, the media content customization sub-options, the manage stations function 728 is presented to the user as a screen display on the users GUI, such as depicted in FIG. 21. Once the manage stations function 728 is completed by the user, and the user selects the “proceed to cart” button 408 on the manage station screen 400, and the customization selection data, including all customization options and sub-options, any data input or selected on the manage stations screen 400 from step 728, are all communicated to the user's cart 730 for the checkout procedure depicted in FIG. 33 described hereinafter.

It will be understood by those skilled in the art that the process for each of media content 2, 704, through media content n 706, that presents the first, second and third decisional prompts, e.g., add to favorites 740, preview 742 and customize media content 2, 744, are presented to the user for selection. For each media content 704, 706 selected, where the user chooses an affirmative answer to the customize media content 2, 744, prompt, again the cascade of a plurality of media customization options for media content 2 are presented to the user for customization decisions, i.e., Customization Option 1, 746, Customization Option 2, 748, Customization Option 3, 750, Customization Option 4, 752 and Customization Option 5, 754, each of which is independently selectable by the user. Thus, the process steps for each media content selection made by the user proceeds in substantially the same manner irrespective of which media content selection the user makes.

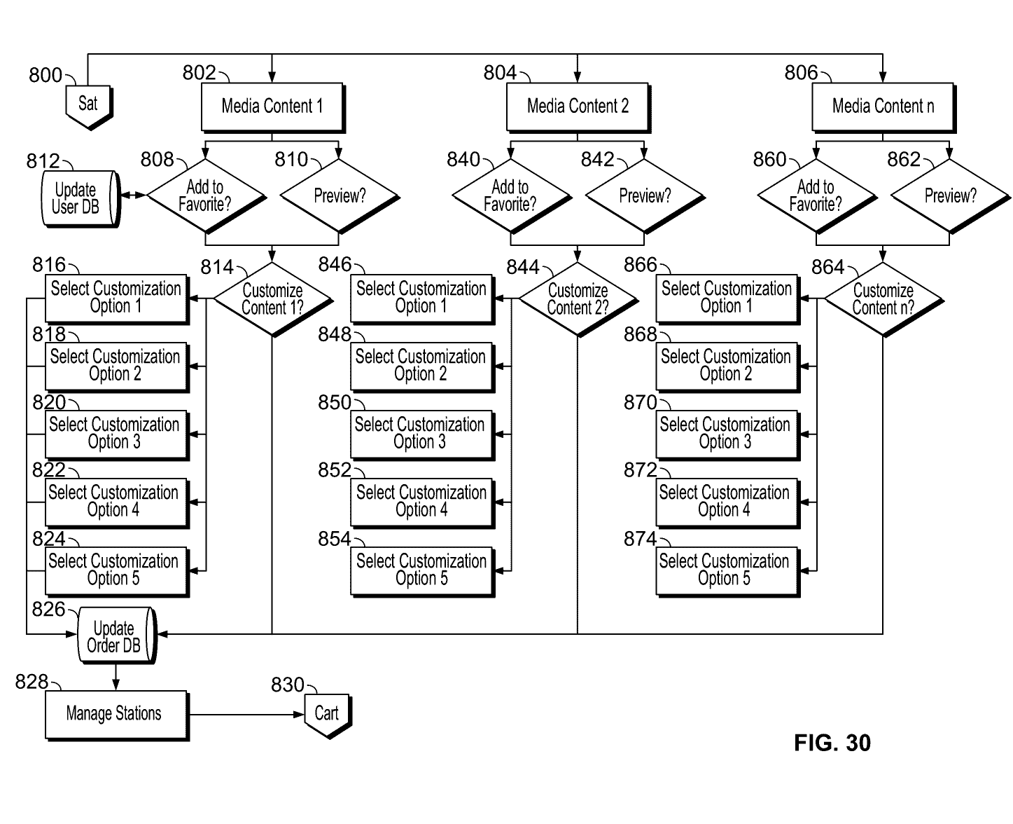

Similarly, as depicted in FIGS. 30-32, substantially the same process steps as described above when TV 700 is the selected broadcast medium are followed where other broadcast media are selected, 600, i.e., satellite 800, internet/streaming 900 and/or radio 1000. Accordingly, the above-description of the operation of the media content selection, user database updates, customization options and sub-options, order database update, manage stations and cart updates, is repeated and incorporated with reference to each other broadcast media option presented for user selection.

FIG. 33 illustrates the checkout process 1000 in accordance with the present invention. As discussed above, as the user enters a media content order by interfacing with a computer to enter an order into the system 10 using the GUI displayed at the user's display, the shopping cart 1030 is regularly updated. When a user activates each prompt in the GUI on the user's display, one of a plurality of records in one of a plurality of databases is updated with data corresponding to the user selection at each prompt. As discussed above, the system 10 utilizes at least one of a plurality of databases, including, for example an order database 1120 and a broadcast station database 114 (FIG. 2). A user order is loaded to the shopping cart 1030 by loading records from a user order database 1102 that is updated as the user enters the order by interfacing with the system 10 and the plurality of screens the system 10 presents to the user on the user's display GUI. Once the shopping cart is complete and displayed on the user's display GUI, a decisional prompt is displayed to the user to keep shopping for more orders or order customization. A plurality of checkout decisional prompts are displayed on the checkout screen displayed on the user's GUI, including the keep shopping prompt 1104, an apply coupon prompt 1108, a delete order item prompt 1106 and a proceed to checkout prompt 1110. If the user does not activate the keep shopping prompt 1104, the apply coupon prompt 1108 or the delete order item prompt 1106 by using his computer to activate the respective prompt, the user must activate the proceed to checkout prompt 1110 in order to advance to the screens or windows for entry of billing information 1112 and entry of payment information 114 each of which prompt the user to enter his/her billing information 1112, such as billing address, telephone number, email address or other user billing identification information, and payment information 1114, such as credit card information, check information, online payment service information, such as, for example, PAYPAL or other electronic payment service or method.

Once the user billing information is entered 1112 and the payment information 1114 is entered and validated by the system 10, the payment information is processed and upon successful order payment processing an order payment confirmation is generated 1116, displayed on the user's GUI and, optionally, communicated to the user, such as by email, 118. Once the order payment confirmation is generated 116, the order database is updated 1120 to reflect that the order has been successfully entered and paid for.

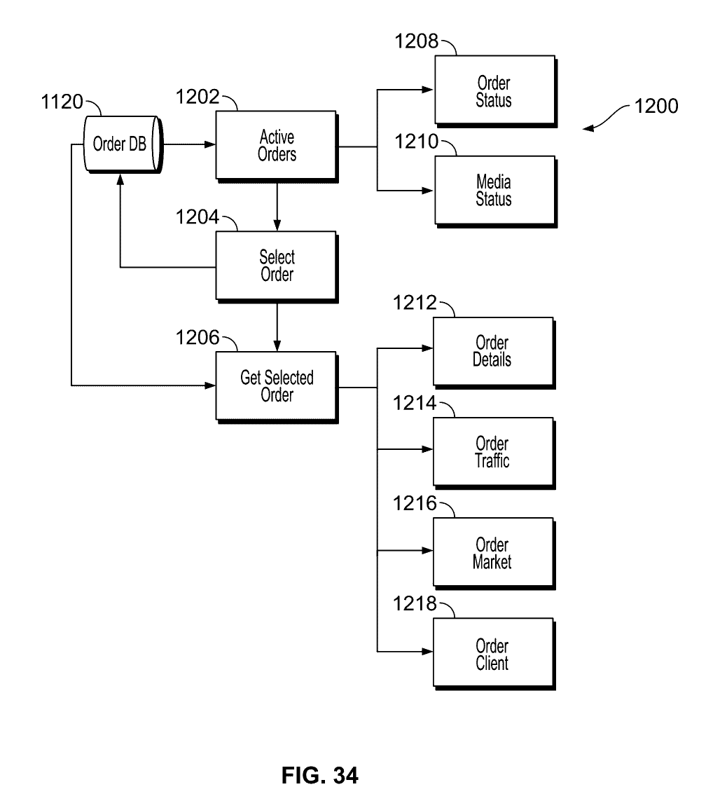

Finally, FIG. 34 depicts the active order status process 1200 in which active orders 1202 read from the order database 1120. The active orders are displayed on the user's GUI and the user may select an order 1204 by interfacing with his/her computer, as illustrated in FIGS. 26 and 27. The selected order is then read 1206 from the order database 1120 and displayed on the individual active order status screen or window depicted in FIG. 27. A menu of individual order status options are individually selectable by the user interfacing with his/her computer and opening an order details screen or window 1212, an order traffic status screen or window 1214, an order market status screen 1216 or an order client screen or window 1218, each of which displays different data pertaining to at least one of a plurality of active orders made by the user on the user's GUI, together with prompts to the user to change or delete different aspects of individual user orders, as illustrated in FIG. 27.

While the system and method of the present invention have been described with reference to the above exemplary embodiments, those skilled in the art will understand and appreciate that variations in hardware platforms, hardware architecture, software programming language, software framework, coding methodology or the like are contemplated by the present invention, the scope of which is intended to be limited only by the claims appended hereto.

What is claimed is:

1. Method for producing and delivering media content, comprising the steps of:
a. Providing a media production template on a computer graphical interface, the media production template defining an advertising production including an audio media segment and a video media segment;
b. Prompting a user to select at least one of a plurality of options to modify at least one of the audio media segment or the video media segment;
c. Based upon user selection of at least one of the plurality of options, modifying the at least one of the audio media segment or the video media segment in the advertising production;
d. Selecting at least one of a plurality of media broadcasting stations to broadcast the advertising production;
e. Converting the modified advertising production into a CODEC specific for the selected at least one of a plurality of media broadcasting stations; and
f. Automatically distributing the converted modified advertising production to the selected at least one of a plurality of media broadcasting stations.

2. The method of claim 1, wherein step b. further comprises the step of displaying a first customization option on a user's computer and prompting the user to select the first customization option.

3. The method of claim 2, further comprising the step of displaying a second customization option on the user's computer based upon the user affirmatively selecting the first customization option by interfacing with the user's computer to actively select the first customization option.

4. The method of claim 1, further comprising the step of displaying on a user's computer an ordering portal, the ordering portal comprising at least one prompt requiring the user to select at least one remote broadcasting computer to send the modified media content data for broadcast.

5. The method of claim 1, wherein the step c. further comprises the step of modifying data selected from the group consisting of audio-visual files, audio files, web files and printer files based upon the user's responses to the at least one of a plurality of prompts displayed on the user's computer.

6. The method of claim 1, wherein step e further comprises the step of reading the selected at least one of a plurality of media broadcasting stations, reading at least one of a plurality of CODECs specific for the selected at least one of a plurality of media broadcasting stations and transcoding a data file containing the modified advertising production to generate a transcoded data file capable of being broadcast at the selected at least one of a plurality of media broadcasting stations.

7. A computer-implemented method for producing and distributing advertising media content to user-selected broadcasting sites, comprising the steps of:
a. Providing a media production template on a computer graphical interface, the media production template having the pre-defined advertising media content,
b. Prompting a user to select at least one of a plurality of options to modify the advertising media content, including options to modify at least one of an audio media segment or a video media segment of the pre-defined advertising media content, each of the plurality of options to modify having a pre-determined pricing value associated therewith;
c. Based upon user selection of at least one of the plurality of options, modifying the at least one of the audio media segment or the video media segment in the advertising media content to produce a modified advertising media content production;
d. Selecting at least one of a plurality of media broadcasting stations to broadcast the advertising production;
e. Converting the modified advertising production into a CODEC specific for the selected at least one of a plurality of media broadcasting stations; and
f. Automatically distributing the converted modified advertising production to the selected at least one of a plurality of media broadcasting stations.

8. System for producing and delivering advertising media content, comprising:
a. An ordering portal operable on a computer, the ordering portal comprising at least one web-page presenting at least one predefined template containing the media content to a user, a plurality of prompts presented by the at least one web-page having user prompts prompting user input to edit the predefined template containing the media, pre-determined pricing associated with each user prompt and at least one order entry prompt that, when activated by a user, completes a media content order and closes the ordering portal;
b. A media content production server that receives the completed media content order from the ordering portal, processes the edited predefined template containing the media content to produce customized media content data and notify the user of the customized media content data; and
c. Media content data distribution server that distributes the media content data to at least one remote broadcasting computer.

9. The system of claim 2, wherein the ordering portal further comprises at least one prompt requiring the user to define at least one remote broadcasting computer to which the customized media content data is to be distributed.

10. The system of claim 1, wherein the customized media content data further comprises data selected from the group consisting of audio-visual files, audio files, web files and printer files.

11. The system of claim 1, wherein the media content data distribution server further comprises a transcoder and a plurality of CODECs, each of the plurality of CODECs being specific for at least one remote broadcasting computer.

12. A system for producing and delivering customizable media advertising content, comprising at least one of a plurality of broadcast station groups, each of the at least one broadcast station groups comprising at least two broadcast stations having an order of relationship with each other.
